(19) United States
(12) Patent Application Publication
(10) Pub. No.: US 2026/0340905 A1
(43) Pub. Date: Oct. 29, 2026

(54) STORAGE MEDIUM STORING PROGRAM FOR GENERATING LAYOUT OF CONTENTS, INFORMATION PROCESSING APPARATUS, AND INFORMATION PROCESSING METHOD

(71) Applicant: CANON KABUSHIKI KAISHA, Tokyo (JP)

(72) Inventor: YOSHINORI HASHIMOTO, Kanagawa (JP)

(21) Appl. No.: 19/655,528

(22) Filed: Apr. 22, 2026

(30) Foreign Application Priority Data
Apr. 25, 2025 (JP) 2025-073761

(51) Int. Cl. G06T 11/60; G06F 3/16

(52) U.S. Cl. CPC G06T 11/60; G06F 3/167; G06T 2200/24

(57) ABSTRACT

In a case of giving an instruction relating to a layout of contents via an interactive interface, it is difficult for a user to correctly specify a target object and give the instruction, unlike a graphical user interface (GUI). The present disclosure receives a change instruction for at least one object among objects included in a layout proposal relating to contents from a user via an interactive interface. Then, another layout proposal is generated by changing the layout proposal based on the change instruction.

### BACKGROUND

### Field of the Technology

The present disclosure relates to a technology for generating a layout of contents.

### Description of the Related Art

In recent years, applications for generating contents such as posters and flyers have been widely used. In such a contents generating application, a technology which displays a plurality of layout proposals in which sizes and arrangement of objects such as an image, an illustration, and a text are different, and receives a user selection of a desired layout has been known (see Japanese Patent Laid-Open No. 2024-11650).

In a case where a user gives an instruction by using an interactive interface in an application for designing a layout of contents, it is difficult to correctly specify an object such as an image or a text and give an instruction.

### SUMMARY

The present disclosure has been made in view of the above-described problem, and an object of the present disclosure is to reflect the intention of the user and improve the convenience in a scene where a layout design of contents is performed by using an interactive interface.

A non-transitory computer readable storage medium according to the present disclosure is a non-transitory computer readable storage medium storing a program for causing a computer to generate a layout of contents by executing the following processing:
causing a display device to display a first layout proposal relating to the contents;
receiving a change instruction for the first layout proposal from a user via an interactive interface; and
generating a second layout proposal of the contents by changing the first layout proposal based on the change instruction.

Features of the present disclosure will become apparent from the following description of embodiments with reference to the attached drawings. The following description of embodiments are described by way of example.

### BRIEF DESCRIPTION OF THE DRAWINGS

FIG. 1 is a diagram showing an example of a configuration of an information processing system;

FIG. 2 is a diagram showing an example of a hardware configuration of an information processing apparatus;

FIG. 3 is a flowchart showing an operation of a Web application according to Embodiment 1;

FIG. 4A is a diagram showing an example of a UI screen;

FIG. 4B is a diagram showing an example of a UI screen;

FIG. 4C is a diagram showing an example of a UI screen;

FIG. 4D is a diagram showing an example of a UI screen;

FIG. 4E is a diagram showing an example of a UI screen;

FIG. 5 is a flowchart showing a detail of editing processing via an interactive I/F according to Embodiment 1;

FIG. 6 is a diagram showing an example of an object table;

FIG. 7A is a diagram showing an example of a UI screen;

FIG. 7B is a diagram showing an example of a UI screen;

FIG. 7C is a diagram showing an example of a UI screen;

FIG. 7D is a diagram showing an example of a UI screen;

FIG. 7E is a diagram showing an example of a UI screen;

FIG. 7F is a diagram showing an example of a UI screen;

FIG. 7G is a diagram showing an example of a UI screen;

FIG. 7H is a diagram showing an example of a UI screen;

FIG. 7I is a diagram showing an example of a UI screen;

FIG. 7J is a diagram showing an example of a UI screen;

FIG. 7K is a diagram showing an example of a UI screen;

FIG. 7L is a diagram showing an example of a UI screen;

FIG. 8 is a flowchart showing a detail of editing processing via an interactive I/F according to Embodiment 2;

FIG. 9A is a diagram showing an example of a UI screen;

FIG. 9B is a diagram showing an example of a UI screen;

FIG. 9C is a diagram showing an example of a UI screen;

FIG. 9D is a diagram showing an example of a UI screen;

FIG. 10 is a flowchart showing a detail of editing processing via an interactive I/F according to Embodiment 3;

FIG. 11A is a diagram showing an example of a UI screen;

FIG. 11B is a diagram showing an example of a UI screen;

FIG. 11C is a diagram showing an example of a UI screen;

FIG. 11D is a diagram showing an example of a UI screen;

FIG. 11E is a diagram showing an example of a UI screen;

FIG. 11F is a diagram showing an example of a UI screen;

FIG. 11G is a diagram showing an example of a UI screen;

FIG. 11H is a diagram showing an example of a UI screen;

FIG. 11I is a diagram showing an example of a UI screen;

FIG. 12A is a diagram showing an example of a UI screen;

FIG. 12B is a diagram showing an example of a UI screen;

FIG. 12C is a diagram showing an example of a UI screen;

FIG. 12D is a diagram showing an example of a UI screen;

FIG. 12E is a diagram showing an example of a UI screen;

FIG. 12F is a diagram showing an example of a UI screen;

FIG. 13A is a diagram showing an example of a UI screen;

FIG. 13B is a diagram showing an example of a UI screen;

FIG. 13C is a diagram showing an example of a UI screen;

FIG. 13D is a diagram showing an example of a UI screen;

FIG. 13E is a diagram showing an example of a UI screen;

FIG. 13F is a diagram showing an example of a UI screen;

FIG. 13G is a diagram showing an example of a UI screen;

FIG. 13H is a diagram showing an example of a UI screen;

FIG. 13I is a diagram showing an example of a UI screen;

FIG. 14A is a diagram showing an example of a UI screen;

FIG. 14B is a diagram showing an example of a UI screen;

FIG. 14C is a diagram showing an example of a UI screen;

FIG. 14D is a diagram showing an example of a UI screen;

FIG. 14E is a diagram showing an example of a UI screen;

FIG. 14F is a diagram showing an example of a UI screen; and

FIG. 14G is a diagram showing an example of a UI screen.

### DESCRIPTION OF THE EMBODIMENTS

Hereinafter, with reference to the attached drawings, the present disclosure is explained in detail in accordance with preferred embodiments. Configurations shown in the following embodiments are merely exemplary and the present disclosure is not limited to the configurations shown schematically.

### First Embodiment

### System Configuration

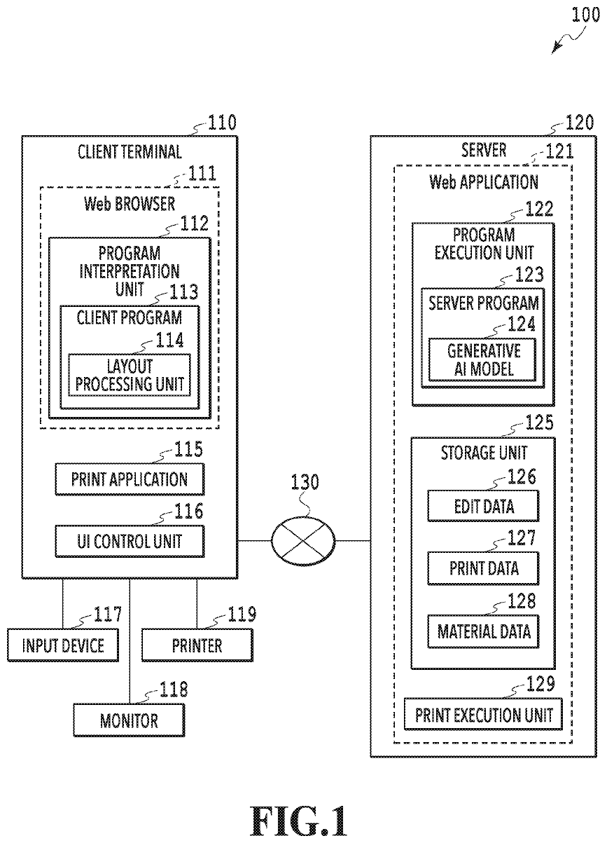

FIG. 1 is a diagram showing an example of a configuration of an information processing system according to the present disclosure. An information processing system 100 operates with a client terminal 110 and a server 120 cooperating with each other via a network 130.

First of all, a configuration of the server 120 will be described. The server 120 provides a Web application 121. The Web application 121 is configured with a program execution unit 122, a storage unit 125, and a print execution unit 129. The program execution unit 122 executes a server program 123 which is a program to be operated in the server 120. The storage unit 125 stores image files, edit data 126, print data 127, material data 128, and the like which are used in the Web application 121. The material data 128 contains data of various templates prepared in advance, layout proposals generated by a generative AI model 124, and various objects included in the layout proposals, and the like. The print execution unit 129 transmits the print data 127 to the print application 115 and performs printing.

Next, a configuration of the client terminal 110 will be described. The client terminal 110 is, for example, a general personal computer or smartphone, and includes a Web browser 111, a print application 115, and a UI control unit 116. The Web browser 111 browses a Website on the Internet and executes the Web application 121. The Web application 121 is generally configured with a client program 113 and a server program 123. The entity of the client program 113 is a program of Hypertext Markup Language (HTML), JavaScript, or the like, or the like which operates on the Web browser 111. The entity of the server program 123 is a program which operates on the server 120. In the case of executing the Web application 121, the client terminal 110 first receives, from the server 120, the client program 113, which configures part of the Web application 121. Subsequently, the Web browser 111 interprets and executes the client program 113 (a script language such as HTML or JavaScript), so that the Web application 121 is activated. More specifically, once a URL is inputted into the Web browser 111, the server 120 transmits, to the Web browser 111, the client program 113, which configures part of the Web application 121. Subsequently, the Web browser 111 receives the client program 113, and a program interpretation unit 112 executes the client program 113, so that the Web application 121 is activated. Note that the client program 113 includes a layout processing unit 114. The layout processing unit 114 receives an input of a prompt by the user, and performs automatic generation of a layout and the like of target contents by using the generative AI (Artificial Intelligence) model 124 of the server program 123. Data of the layout and the like (products) generated by the generative AI model 124 is stored in the storage unit 125 as material data 128, and is also transmitted to the client terminal 110 and displayed in a user interface screen (UI screen) of the client terminal 110. The print application 115 receives the print data 127 from the server 120, and causes a printer 119, which is connected to the client terminal 110 directly (or via the network 130), to execute print processing.

The printer 119 executes print processing based on print data received via the print application 115. The input device 117 is a device for the user to perform an input operation into the information processing system 100, and includes, for example, a keyboard or a pointing device for performing manual input and a microphone for performing voice input, and the like. The monitor 118 is a display device for displaying image information of a UI screen and the like outputted by the UI control unit 116. The input device 117 may be a touch panel which is integrated with the monitor 118 and allows input through direct touch on the monitor 118.

Note that the system configuration shown in FIG. 1 is an example, and the configuration is not limited to this. For example, the program execution unit 122, the storage unit 125, and the print execution unit 129 included in the Web application 121 may be implemented respectively in separate server apparatuses. In addition, for example, the client terminal 110 may be configured to include the input device 117 and the monitor 118. Moreover, the present disclosure can also be applied to an integrated information processing apparatus having both client function and server function, that is, an information processing apparatus equipped with a function of a generative AI service which is provided by the server 120.

### Hardware Configuration

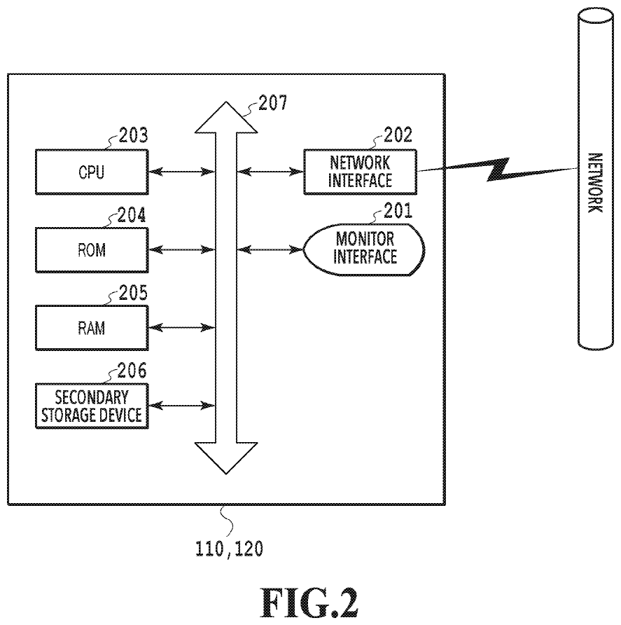

FIG. 2 is a diagram showing an example of a hardware configuration of an information processing apparatus which is common to the client terminal 110 and the server 120. A monitor interface 201 is an interface via which to input and output image information such as a UI screen into and from the monitor 118. A network interface 202 is connected to the network 130, and communicates with the server 120 and other network devices. The method for the communication may be wired or wireless. A CPU 203 is a central processing unit which executes programs read from a ROM 204, a RAM 205, a secondary storage device 206, and the like. The ROM 204 is a non-volatile memory in which built-in programs and data are recorded. The RAM 205 is a volatile memory which provides a temporary memory area. The secondary storage device 206 is a large-capacity storage device represented by an HDD or a flash memory. It is also possible to connect and operate a computer which does not include these pieces of hardware from another computer by means of remote desktop, remote shell, or the like. These units are connected via an input-output interface 207.

### Web Application

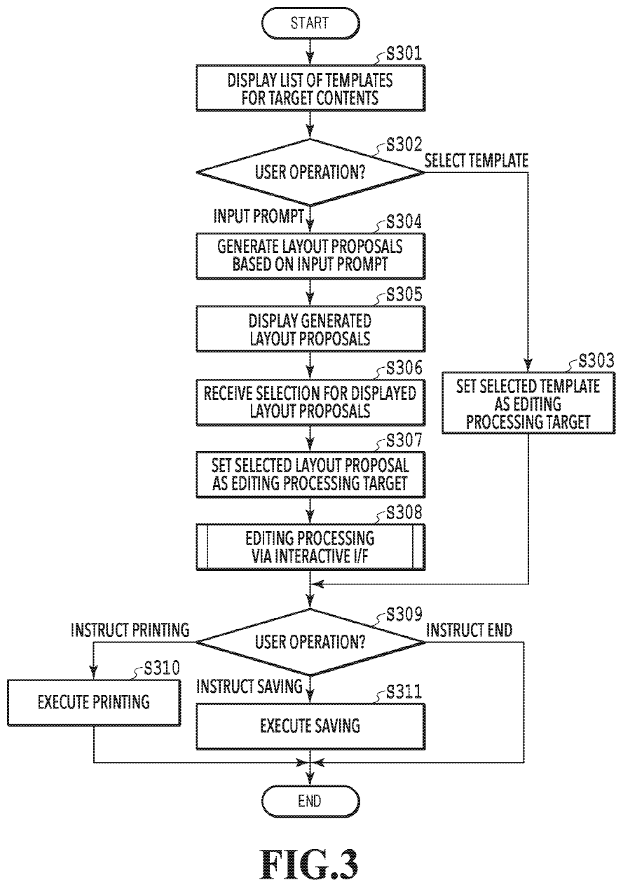

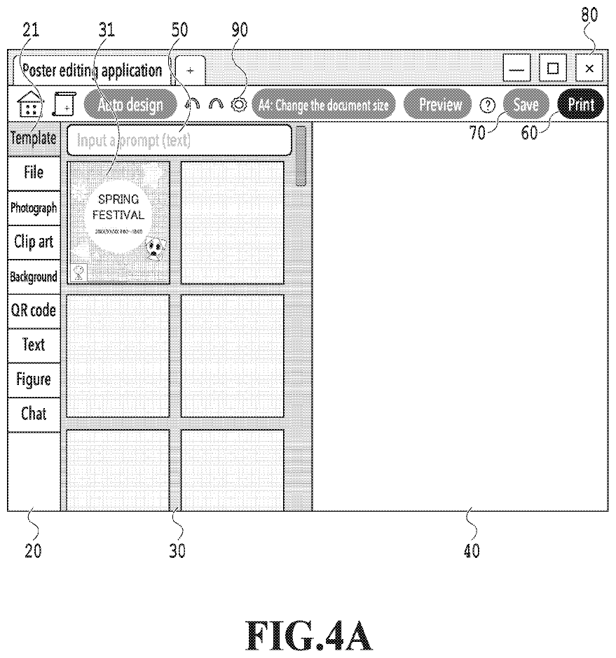

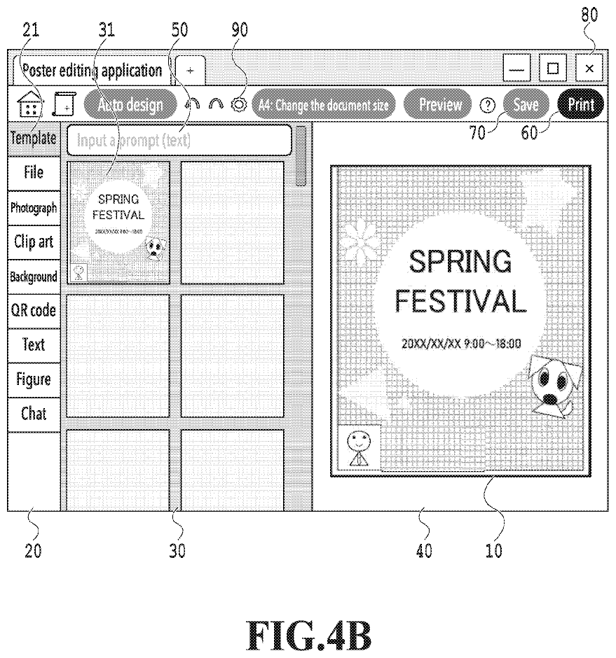

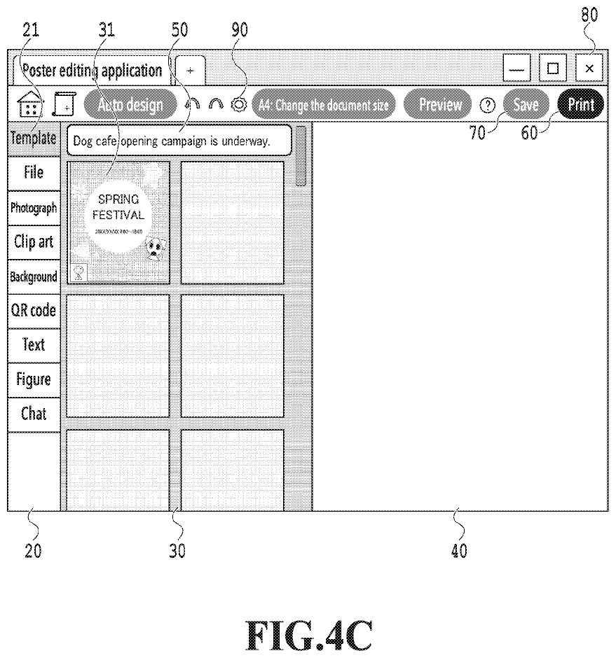

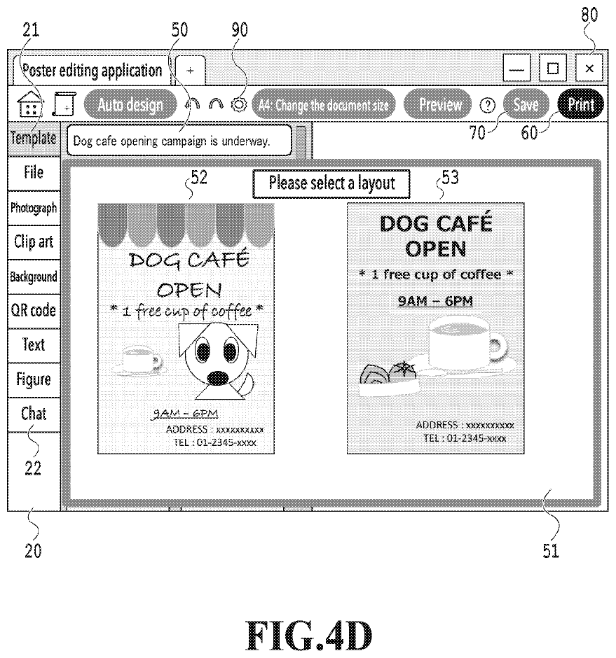

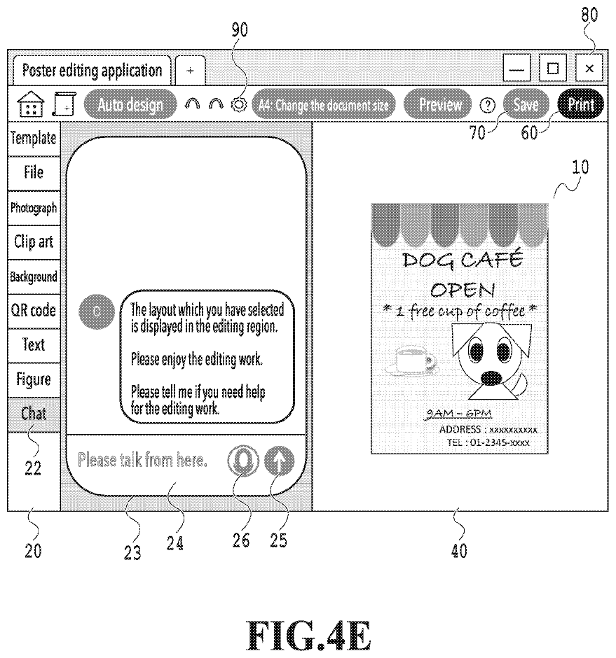

Subsequently, an operation of the Web application 121 will be described by using a flowchart of FIG. 3 and examples of UI screens of FIG. 4A to FIG. 4E. In the present embodiment, a poster editing application will be described as an example, but the Web application 121 is not limited to a poster editing application. For example, the present disclosure can be applied to various general pieces of application software which deal with a layout of contents, such as a photo album editing application.

Once the user activates the Web application 121, a series of processings shown in the flowchart of FIG. 3 is started. Each step of the flowchart of FIG. 3 is implemented by the CPU 203 reading out a predetermined program from the ROM 204 or the like, deploying the predetermined program onto the RAM 205, and executing the predetermined program. Note that in the following description, sign “S” means a step.

First, in S301, the CPU 203 displays, based on a selecting operation of the user, a list of templates corresponding to the kind of contents to be generated. The template is a layout proposal prepared in advance, and is prepared in advance for each kind of contents such as a poster, a flyer, or a calendar, and is held as the material data 128. The CPU 203 displays a UI screen shown in FIG. 4A on the monitor 118 via the UI control unit 116. The UI screen of FIG. 4A is configured with a category selection area 20, a template selection area 30, an editing area 40, a prompt entry field 50, and the like. In the category selection area 20, there is a chat button 22 for the user to make an operation instruction via an interactive interface (interactive I/F). For example, in a case where the user selects “poster” as target contents, and presses down a template selection button 21 in the category selection area 20, the CPU 203 displays, in the template selection area 30, a list of templates for a poster, which are prepared in advance.

In S302, the CPU 203 switches processing to be executed next based on a user operation on the displayed UI screen. Specifically, in a case where the detected user operation is a selecting operation (for example, mouseover+click) on a specific template in the template selection area 30, the CPU 203 proceeds to S303. On the other hand, in a case where the detected user operation is not a selecting operation of a specific template in the template selection area 30, but an input operation of a prompt (text) into the prompt entry field 50, the CPU 203 proceeds to S304.

In S303, the CPU 203 sets a layout as an editing processing target based on the template according to the user selection. Specifically, the CPU 203 obtains, from the server 120, data of the template according to the user selection, and displays the template in the editing area 40 as a layout 10 of the editing target. FIG. 4B shows a UI screen in a case where the user has performed an operation of selecting a template 31 from the template selection area 30, and the UI screen transitions from the state of FIG. 4A to such a UI screen. In the UI screen of FIG. 4B, a layout 10 corresponding to the template 31 according to the user selection is displayed in the editing area 40. After the processing of S303 ends, the CPU 203 proceeds to S309.

In S304, the CPU 203 generates a layout proposal using the generative AI model 124 based on the input prompt. FIG. 4C is an example of a UI screen in a case where a character string (text) “Dog cafe opening campaign is underway.” has been inputted into the prompt entry field 50 in order to generate a layout for an opening campaign of a dog cafe. In the state of the UI screen of FIG. 4C, for example, in a case where it is detected that the Enter key of the keyboard is pressed down, the CPU 203 transmits, as an input prompt, the text inputted into the prompt entry field 50 to the server 120 implemented with an AI image generator such as “Stable Diffusion”, for example, to make a request for generating a poster layout. Note that in the present embodiment, the input prompt is Japanese text input, but may be, for example, English text input, and the used language is not limited. Upon receipt of this generation request, the server 120 generates, by using the generative AI model 124, a layout proposal based on the input prompt contained in the generation request, and returns data of the layout proposal to the client terminal 110.

In S305, the CPU 203 receives the data of the layout proposal generated by the generative AI model 124 from the server 120, and displays the layout proposal on the UI screen. In this way, the UI screen transitions from the state of FIG. 4C to the state of FIG. 4D. Now, in the UI screen of FIG. 4D, two different layout proposals 52 and 53 generated by the generative AI model 124 are displayed in a display area 51. In addition, In the upper portion of the display area 51, a message which prompts selecting a layout is displayed. Note that here, an example of the case where two layout proposals are generated is shown for convenience of the description, the number of layout proposals to be generated by the generative AI and the number of layout proposals displayed are not limited to this.

In S306, the CPU 203 receives a selecting operation of a specific layout by the user on the displayed UI screen. Specifically, the CPU 203 receives an operation (for example, mouseover+click) of selecting a specific layout proposal among a plurality of layout proposals in the display area 51. Moreover, in the present embodiment, it is assumed that the CPU 203 also receives a selecting operation of the chat button 22 in the category selection area 20, following the selecting operation of a specific layout proposal.

In S307, the CPU 203 sets the layout proposal according to the user selection as an editing processing target. Specifically, the CPU 203 displays, in the editing area 40, the layout proposal according to the user selection. FIG. 4E is a UI screen in a case where the user has selected the layout proposal 52. In the UI screen of FIG. 4E, there are an interactive area 23 for performing the editing processing and an editing area 40 in which a layout proposal 10 according to the selection is displayed. In addition, the interactive area 23 contains an input field 24, a send button 25, and a voice input button 26. The UI screen transitions from the state of FIG. 4D to such a UI screen.

In S308, the CPU 203 executes editing processing of the layout based on an editing operation by the user via the interactive I/F. Specific examples of the editing operation include addition, movement, size change, color change, and the like of an object. A detail of this editing processing via the interactive I/F will be described later. After the processing of S308 ends, the CPU 203 proceeds to S309.

In S309, the CPU 203 switches processing to be executed next based on a user operation on the displayed UI screen. Specifically, in a case where the detected user operation is the pressing down of a print button 60, the CPU 203 proceeds to S310, and in a case where the detected user operation is the pressing down of a save button 70, the CPU 203 proceeds to S311. On the other hand, in a case where the detected user operation is the pressing down of an end button 80, the CPU 203 ends the editing processing.

In S310, the CPU 203 causes, via the print application 115, the printer 119 to execute print processing based on poster data after the editing processing. In S311, the CPU 203 saves data of a layout after the editing processing in the secondary storage device 206 or the like as poster data. After the processing of any of S310 and S311 ends, the CPU 203 ends the operation of the Web application 121.

The above is the overview of the operation of the Web application 121. Note that an environment setting button 90 in FIG. 4A to FIG. 4E is a button for the user to switch a display in performing the editing work in accordance with the user's preference. Examples of the environment setting include a display setting of a trimming area, a display setting of a grid or guide line which roughly indicates the arrangement in the editing area 40, and the like.

### Detail of Editing Processing via Interactive I/F

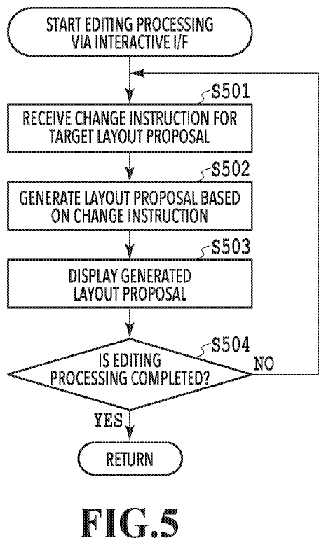

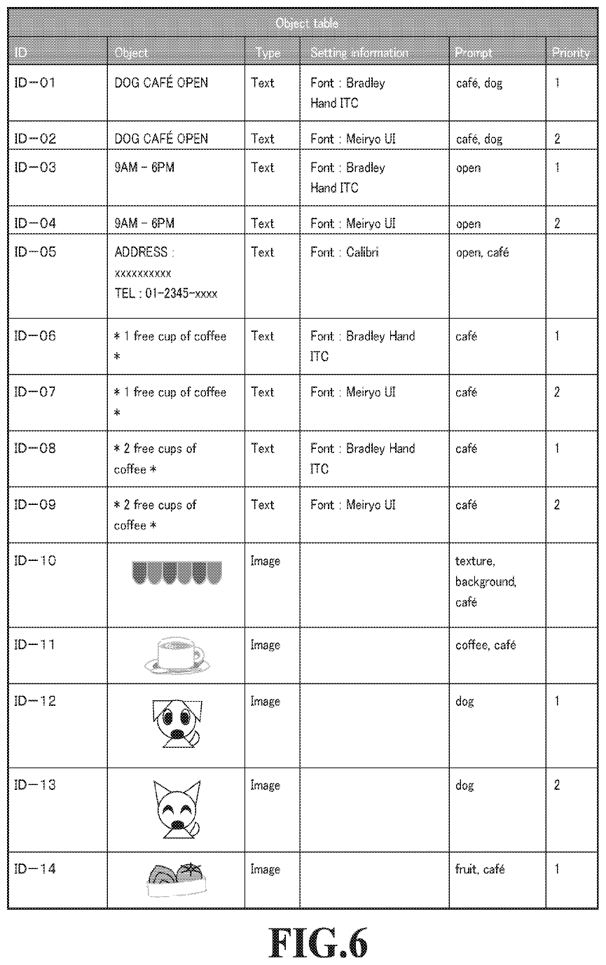

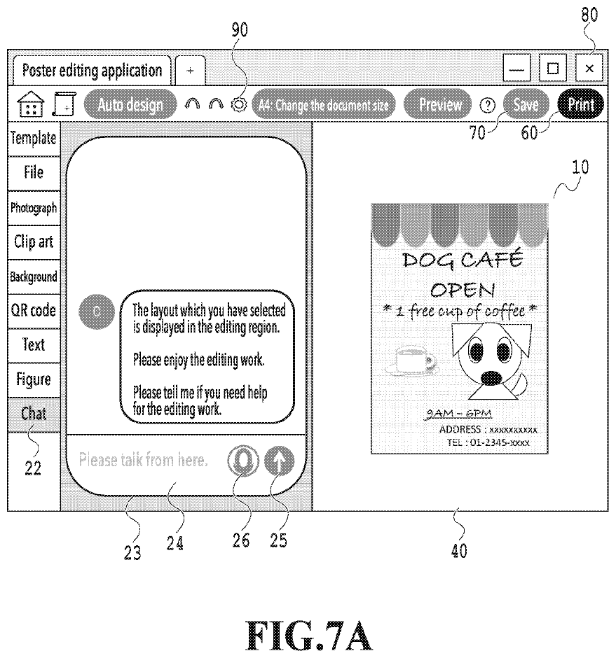

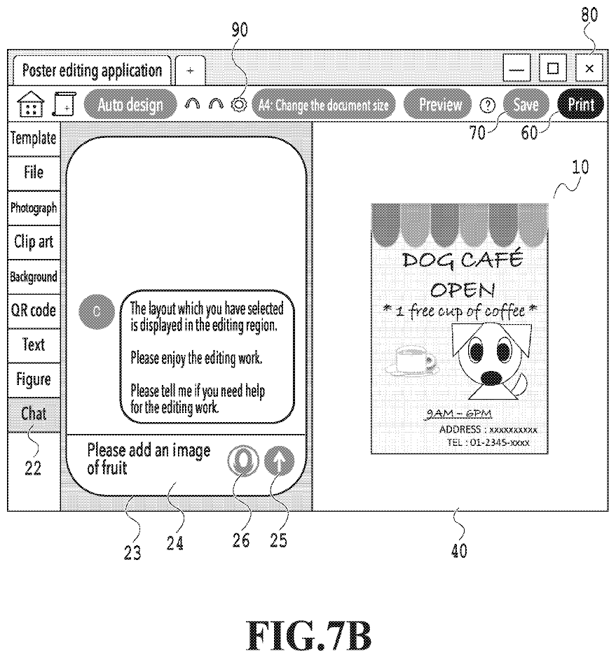

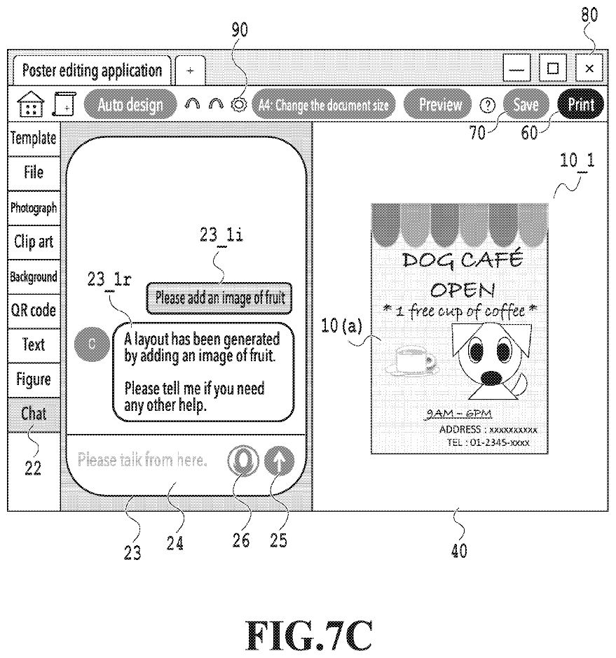

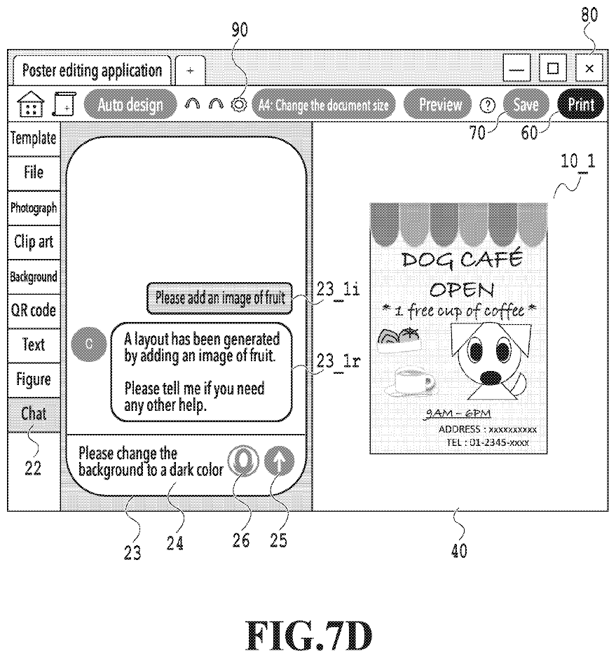

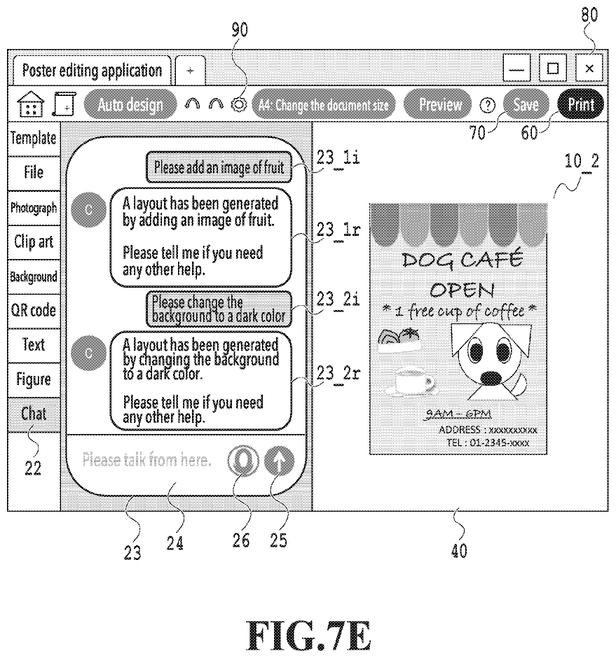

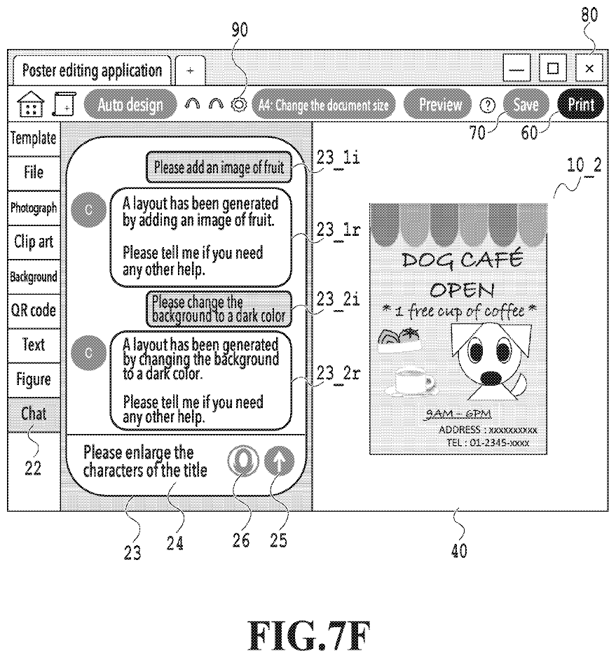

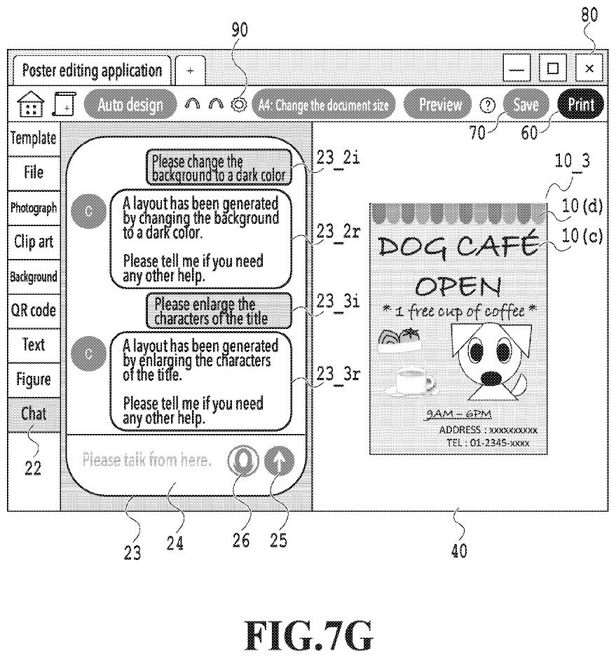

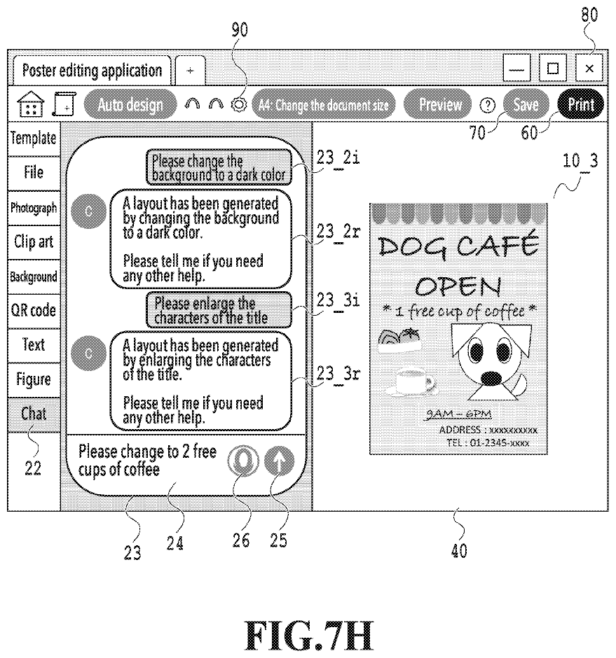

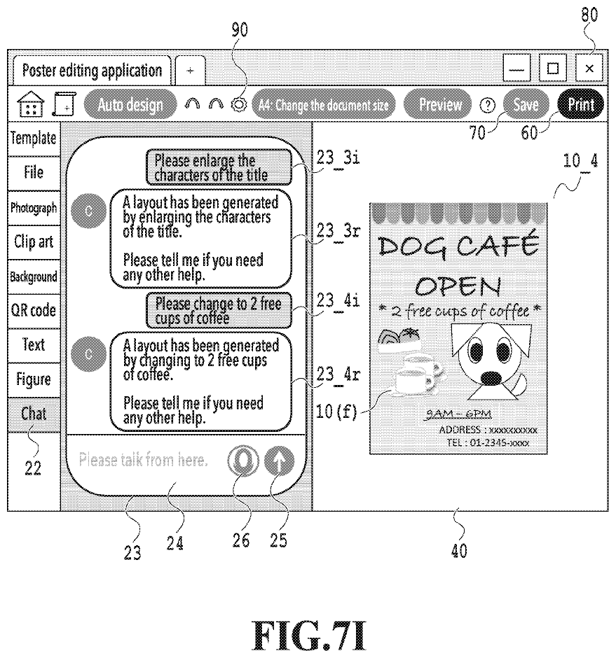

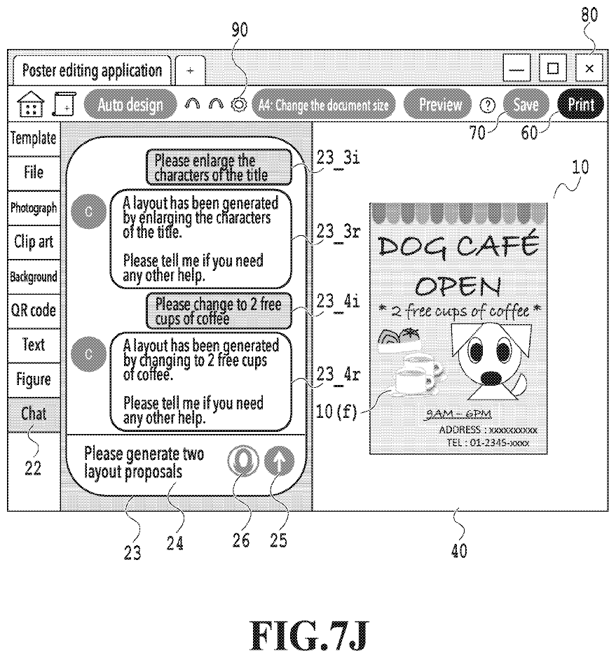

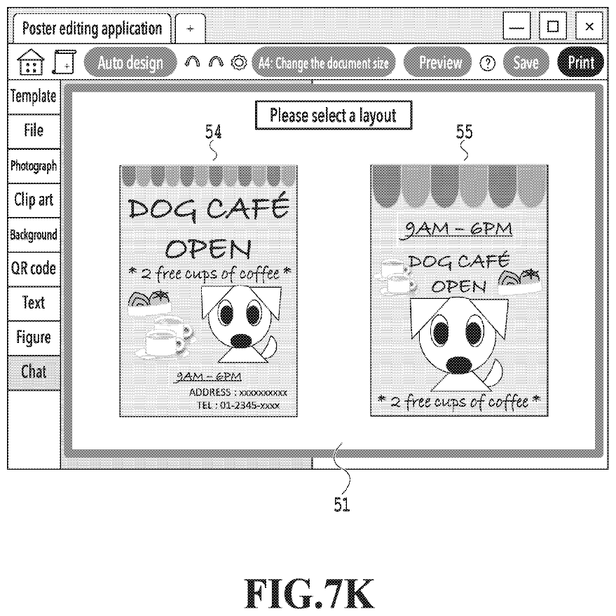

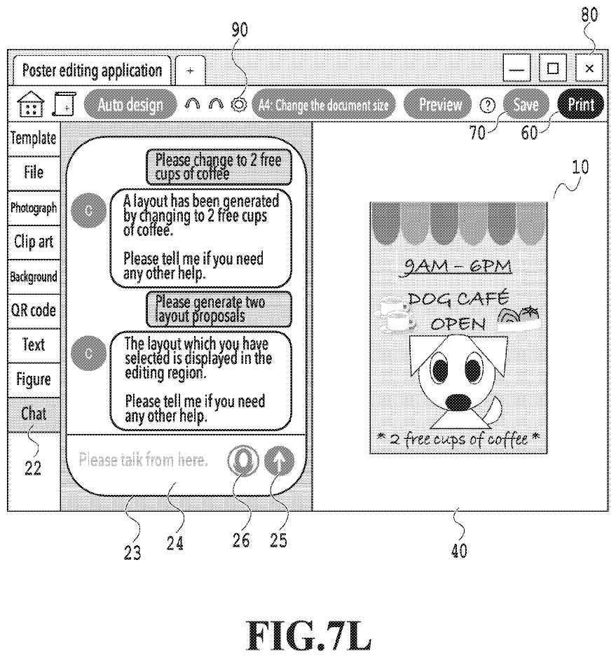

Subsequently, layout editing via a bi-directional interactive I/F, which is a feature of the present embodiment, will be described by using a flowchart of FIG. 5, an object table of FIG. 6, and examples of UI screens of FIG. 7A to FIG. 7I. In the present embodiment, user instructions such as addition or change of an object to a layout of an editing target, and the like are received via the interactive I/F, and a layout in accordance with the intention of the user is generated by the generative AI model 124, and is presented to the user. Here, a case where the editing processing is started via a UI screen of FIG. 7A, which corresponds to aforementioned FIG. 4E, will be described as an example. The processing of the flowchart of FIG. 5 is started in response to an operation (for example, mouseover+click on the input field 24) of focusing on the input field 24 of the interactive area 23 by the user in the UI screen of FIG. 7A. Note that in the following description, sign “S” means a step.

In S501, the CPU 203 receives a change instruction for an editing target layout displayed in the editing area 40. FIG. 7B shows a UI screen in a case where the user has inputted a character string (text) “Please add an image of fruit” into the input field 24 of the interactive area 23 in the UI screen of FIG. 7A. In a case where the user pressed down the send button 25 in the UI screen of FIG. 7B, the CPU 203 proceeds to processing of S502. Note that here, the case of receiving the change instruction in a text format has been described as an example; however, the configuration is not limited to this. For example, the change instruction may be received in a voice format. Specifically, it is also possible for the user to give the change instruction by using the user's own voice via the microphone, which is the input device 117, after pressing down the voice input button 26.

In S502, the CPU 203 generates a new layout proposal based on the change instruction received in S501. The processing of the present step is basically the same as aforementioned S304, and the CPU 203 generates an input prompt based on the change instruction, and transmits a request for generating a new layout proposal to the server 120. In this event, the CPU 203 may, for example, refer to the object table shown in FIG. 6, designate an image of fruit to be added, and make a request for generating a new layout proposal to the server 120. Specifically, in a case where the content of the change instruction is “Please add an image of fruit”, the CPU 203 searches an object table as shown in FIG. 6 by using, as keywords, “fruit” contained in the input prompt and the type “image” of an object to be added. Then, in a case where an object for which the keywords match is found, the CPU 203 obtains data of the object from the object table. In the object table of FIG. 6, various pieces of information such as ID, content, type, additional information (the font, the color, and the like in the case of a text object), prompt, and priority are stored for each object. In this object table, every time the generative AI model 124 generates a layout proposal based on an input prompt in S304, for example, the above-described various pieces of information for an object included in the layout proposal are added or updated. The type, additional information, and the like of an object may be extracted by performing image analysis or the like on a generated layout proposal. Now, since the input prompt contains “fruit”, and the type of the object to be added is “image”, an image of “ID-14” for which these keywords match is obtained from the object table of FIG. 6. Note that the CPU 203 may generate a new layout proposal using a known technology as disclosed in Japanese Patent Laid-Open No. 2024-11650, for example, by itself or via an external apparatus without using a generative AI. In addition, in the generation of a new layout proposal, adjustment processing of making expansion, contraction, or the like of an existing object in an editing target layout may be performed as necessary in conformity to a framework, such as a balance between objects, of the new layout proposal to be generated.

In S503, the CPU 203 displays the layout proposal newly generated in S502. Specifically, the CPU 203 displays the generated new layout proposal 10_1 in the editing area 40 on the UI screen as shown in FIG. 7C. To the new layout proposal 10_1, an image object 10(a) of fruit has been added. In addition, in the interactive area 23 of the UI screen of FIG. 7C, a text message 23_1i indicating the change instruction of the user and a text message 23_1r as a reply to the text message 23_1i are displayed. In this way, it becomes possible for the user to generate a layout intended by the user by bi-directionally communicating with the generative AI via the interactive I/F.

In S504, the CPU 203 determines whether to continue or complete the editing processing via the interactive I/F. In a case where a user operation of inputting a new change instruction is detected, the CPU 203 returns to S501 for continuing the editing processing, and repeats the processing based on the new change instruction. On the other hand, in a case where a user operation other than a new change instruction is detected, the CPU 203 exits the present processing, and returns to the flowchart of aforementioned FIG. 3. Here, a specific example in a case where new change instructions have been inputted multiple times will be described.

First, as shown in FIG. 7D, for example, it is assumed that the user has inputted a change instruction “Please change the background to a dark color” into the input field 24 and has pressed down the send button 25. In this case, the CPU 203 executes aforementioned S501 to S503 based on the change instruction, so that the UI screen transitions to the state shown in FIG. 7E. On the UI screen of FIG. 7E, a layout proposal 10_2 in which the background color has been changed to a dark color is displayed in the editing area 40. In addition, in the interactive area 23 of the UI screen of FIG. 7E, a text message 23_2i indicating the change instruction of the user and a text message 23_2r as a reply to the text message 23_2i are additionally displayed.

Further continuously, as shown in FIG. 7F, it is assumed that the user has inputted a change instruction “Please enlarge the characters of the title” into the input field 24 and has pressed down the send button 25. In this case, the CPU 203 executes aforementioned S501 to S503 based on the change instruction, so that the UI screen transitions to the state shown in FIG. 7G. On the UI screen of FIG. 7G, a layout proposal 10_3 containing a text object 10(c) in which the character size of the title has been enlarged is displayed in the editing area 40. In addition, in the layout proposal 10_3, adjustment processing for size change has been made on a figure object 10(d) such that the figure object 10(d) does not overlap the text object 10(c) of the enlarged title. In addition, in the interactive area 23 of the UI screen of FIG. 7G, a text message 23_3i indicating the change instruction of the user and a text message 23_3r as a reply to the text message 23_3i are additionally displayed. In addition, with this display, the old text messages 23_1i and 23_1r which did not fit in the interactive area 23 have disappeared.

Further continuously, as shown in FIG. 7H, it is assumed that the user has inputted a change instruction “Please change to 2 free cups of coffee” into the input field 24 and has pressed down the send button 25. In this case, the CPU 203 executes aforementioned S501 to S503 based on the change instruction, so that the UI screen transitions to the state shown in FIG. 7I. On the UI screen of FIG. 7I, a layout proposal 10_4 containing a text object 10(e) which is obtained by changing the text content from “*1 free cup of coffee” to “*2 free cups of coffee” is displayed in the editing area 40. In addition, in the layout proposal 10_4, adjustment processing of changing the image object of 1 cup of coffee to an image object 10(f) of 2 cups of coffee has been made along with the change of the number of free cups of coffee of coffee from 1 to 2. In addition, in the interactive area 23 of the UI screen of FIG. 7I, a text message 23_4i indicating the change instruction of the user and a text message 23_4r as a reply to the text message 23_4i are additionally displayed. In addition, with this display, the old text messages 23_2i and 23_2r which did not fit in the interactive area 23 have disappeared.

As described above, in the present embodiment, it is possible not only to change the arrangement as well as expansion or contraction of objects present in a layout of the editing target, but also to cause, via the interactive I/F, the generative AI to generate a layout proposal in which a new text object or image object has been added. Moreover, in this event, in a case where the received change instruction is such a change instruction of correcting the content of a certain object, the generative AI may execute adjustment processing of changing the content of another relevant object in conformity to the changed content.

The above is a detail of the layout editing processing via the bi-directional interactive I/F according to the present embodiment. Note that in the present embodiment, an example in which change instructions on a layout proposal of the editing target are received separately multiple times, and the change processing on the layout proposals is repeatedly executed has been described; however, the configuration is not limited to this. For example, a configuration in which a plurality of change instructions are received collectively in the input field 24 may be employed.

### Modifications

In the above-described embodiment, one layout proposal is generated and displayed in the editing area 40. However, a plurality of layout proposals may be generated by the generative AI and displayed. Specifically, first, as shown in a UI screen of FIG. 7J, a user instruction such as “Please generate two layout proposals” is received in the input field 24. Next, as shown in a UI screen of FIG. 7K, two layout proposals 54 and 55 are displayed in the display area 51 and presented to the user, and receives selection by the user from these. Then, as shown in a UI screen of FIG. 7L, a layout proposal according to the selection of the user is displayed in the editing area 40 as an editing target, and so on.

In addition, in the above-described embodiment, editing via the interactive I/F is performed on the layout proposal initially generated by the generative AI; however, the configuration is not limited to this. For example, the editing may be applied to a template included in an application in advance. Specifically, a configuration in which in a case where the selection of a template has been detected in S302, the template according to the selection is be set as an editing target, and the processing transitions to S308 is employed. That is, the target which is to be edited by the user via the interactive I/F may be a layout proposal generated by a generative AI, or may be a template prepared in advance, or may be a combination of these. In addition, as another application example, data of images and texts which were used in layouts of various contents generated by the user using another application or the like in the past may be read out and applied.

As described above, according to the present embodiment, it becomes possible to perform layout editing of contents while correctly reflecting the intention of the user via the bi-directional interactive I/F.

### Embodiment 2

Next, an aspect to improve accuracy in a case where the user gives a change instruction by adding identification information to each object included in a layout proposal present in an editing area will be described as Embodiment 2. Note that in the following description, the description of contents common with the aforementioned Embodiment 1 will be omitted, and editing processing via the interactive I/F which is a difference from Embodiment 1 will be described. In addition, in terms of the same configurations as in Embodiment 1, the same signs are added, or the same names are used, so that the description thereof is omitted as appropriate.

### Detail of Editing Processing via Interactive I/F

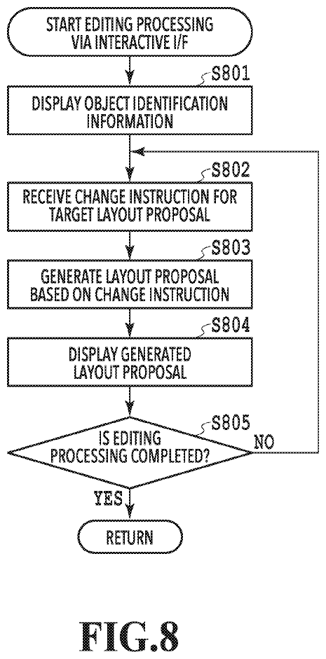

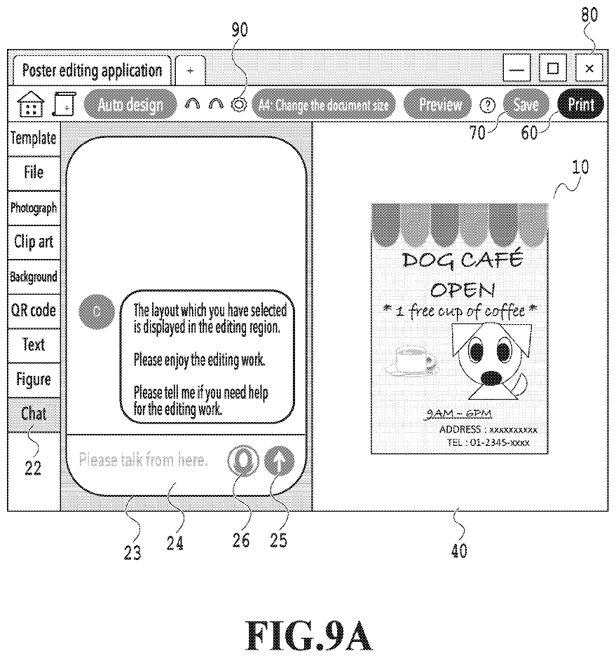

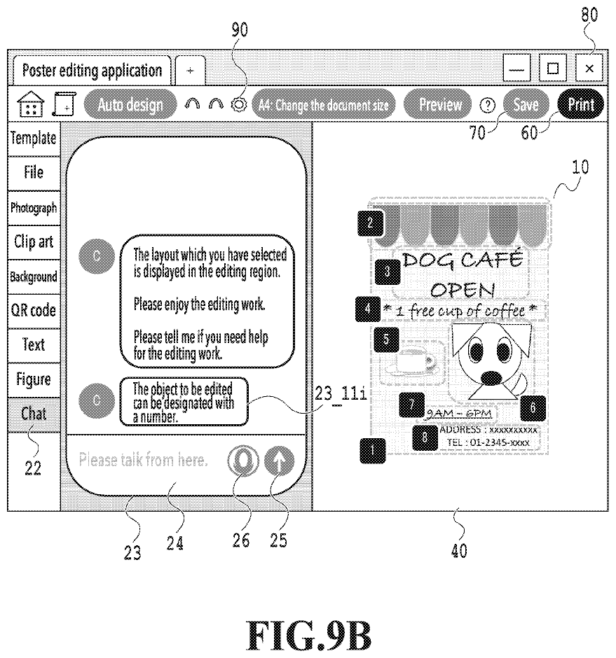

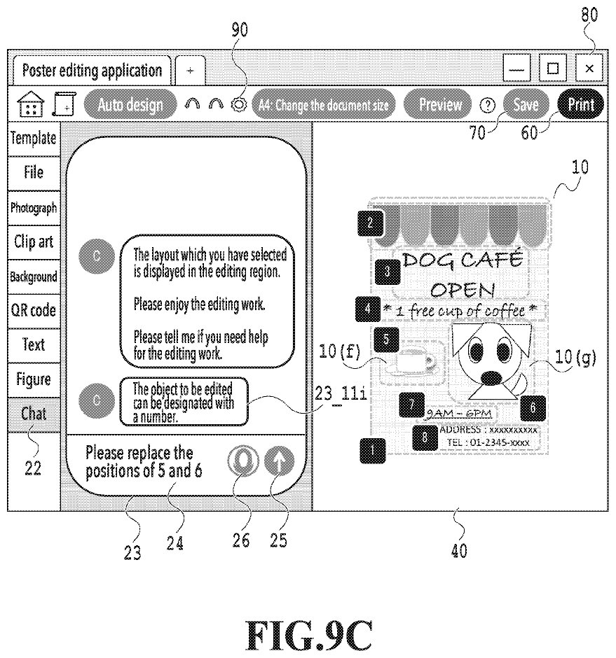

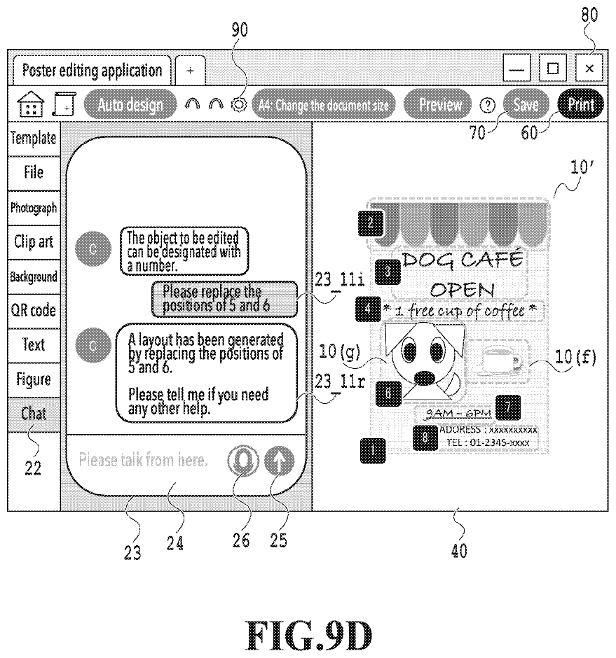

Layout editing via a bi-directional interactive I/F, which is a feature of the present embodiment, will be described by using a flowchart of FIG. 8 and examples of UI screens of FIG. 9A to FIG. 9D. In the present embodiment, identification information is displayed with each object in a layout of an editing target, and a new layout proposal is generated and displayed while it is made possible to receive a change instruction of an object using the identification information. Here, a case where the editing processing is started via a UI screen of FIG. 9A, which corresponds to aforementioned FIG. 4E, will be described as an example. The processing of the flowchart of FIG. 8 is started in response to an operation (for example, mouseover with the cursor) of focusing on the input field 24 of the interactive area 23 by the user in the UI screen of FIG. 9A. Note that in the following description, sign “S” means a step.

In S801, as shown in FIG. 9B, the CPU 203 adds and displays identification information to and with each of objects included in the layout proposal in the editing area 40. The identification information is information which allows each of the objects included in the layout of the editing target to be uniquely specified. In the example of FIG. 9B, identification numbers 1 to 8 corresponding to the respective objects in one-to-one correspondence are displayed near the respective objects as identification information. In addition, in the interactive area 23 of the UI screen of FIG. 9B, a text message 23_11i indicating that the subsequent editing work can be received with an identification number is displayed.

In S802, the CPU 203 receives a change instruction for an editing target layout displayed in the editing area 40. FIG. 9C shows a UI screen in a case where the user has inputted a character string (text) “Please replace the positions of 5 and 6” into the input field 24 of the interactive area 23 in the UI screen of FIG. 9B. Now, an identification number 5 corresponds to an image object 10(f) of a coffee cup, and an identification number 6 corresponds to an image object 10(g) of a dog. In a case where the user pressed down the send button 25 in the UI screen of FIG. 9C, the CPU 203 proceeds to processing of S803.

In S803, the CPU 203 generates a new layout proposal based on the change instruction received in S501. The processing of the present step is basically the same as aforementioned S304, and the CPU 203 generates an input prompt based on the change instruction, and transmits a request for generating a new layout proposal to the server 120.

In S804, the CPU 203 displays the layout proposal newly generated in S803. Specifically, the CPU 203 displays the generated new layout proposal 10′ in the editing area 40 on the UI screen as shown in FIG. 9D. In this way, the new layout proposal is set as the editing processing target. In the new layout proposal 10′, the image object 10(f) of a coffee cup and the image object 10(g) of a dog have been replaced with each other. In addition, in the interactive area 23 of the UI screen of FIG. 9D, a text message 23_11i indicating the change instruction of the user and a text message 23_11r as a reply to the text message 23_11i are displayed. In this way, it becomes possible for the user to generate a layout intended by the user by bi-directionally communicating with the generative AI via the interactive I/F using the identification information added to each object.

In S805, the CPU 203 determines whether to continue or complete the editing processing via the interactive I/F. In a case where a user operation of inputting a new change instruction is detected, the CPU 203 returns to S801 for continuing the editing processing, and repeats the processing based on the new change instruction. On the other hand, in a case where a user operation other than a new change instruction is detected, the CPU 203 exits the present processing, and returns to the flowchart of aforementioned FIG. 3. The above is a detail of the layout editing processing via the bidirectional interactive I/F according to the present embodiment.

As described above, in the present embodiment, the user can make various change instructions by using identification information added to each object in a layout of the editing target in the layout editing of contents via the interactive I/F.

### Embodiment 3

Next, an aspect to improve accuracy in a case where the user gives a change instruction by proceeding editing processing, while checking, via an interactive I/F, whether an object according to the received change instruction is an object intended by the user will be described as Embodiment 3. Note that in the following description, the description of contents common with the aforementioned Embodiment 1 will be omitted, and editing processing via the interactive I/F which is a difference from Embodiment 1 will be described. In addition, in terms of the same configurations as in Embodiment 1, the same signs are added, or the same names are used, so that the description thereof is omitted as appropriate.

### Detail of Editing Processing via Interactive I/F

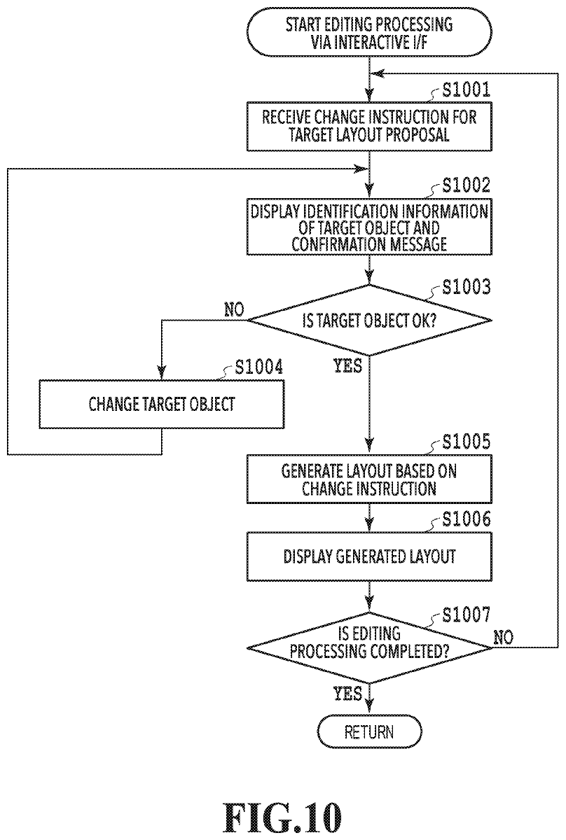

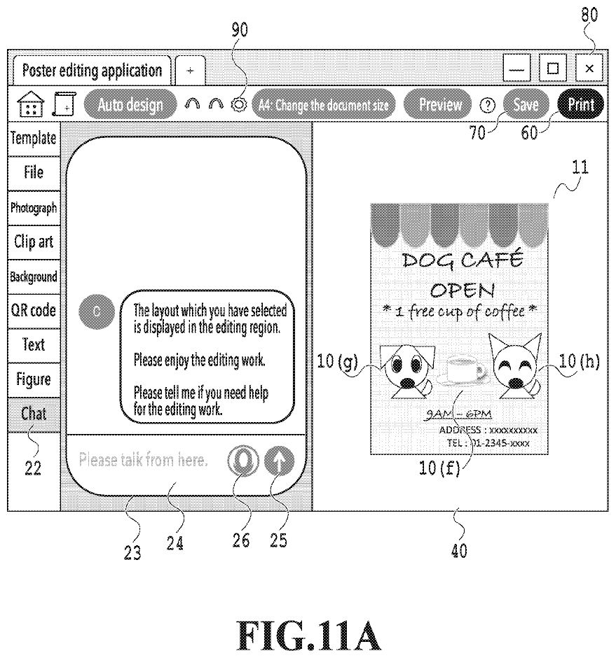

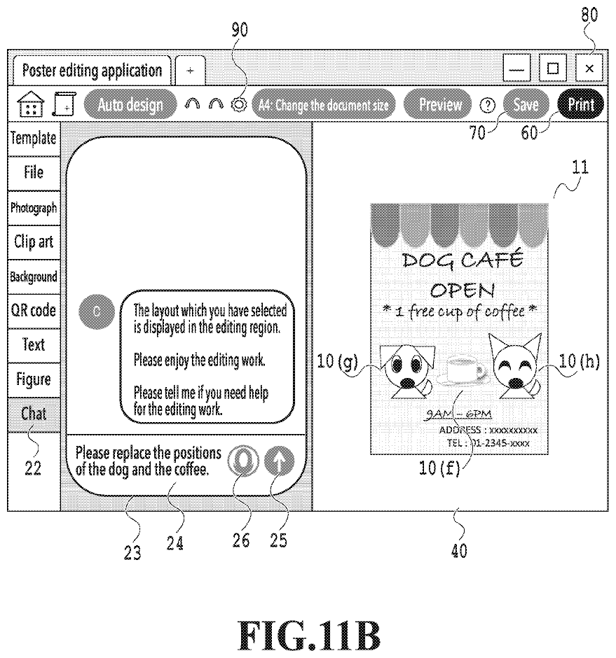

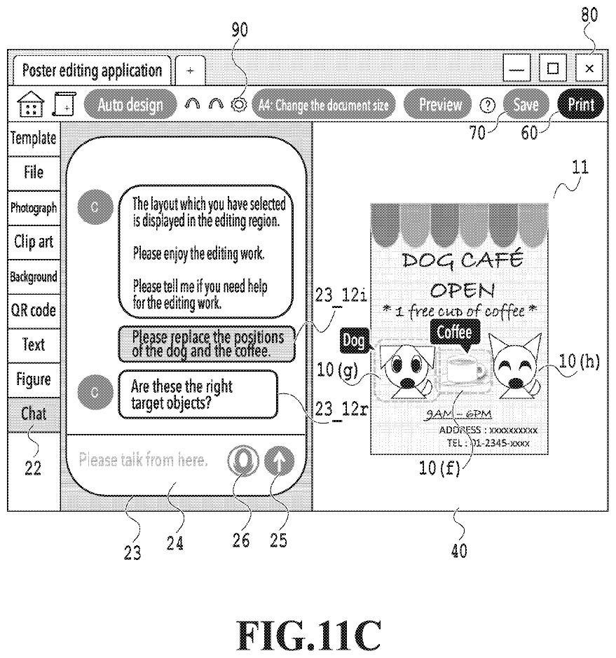

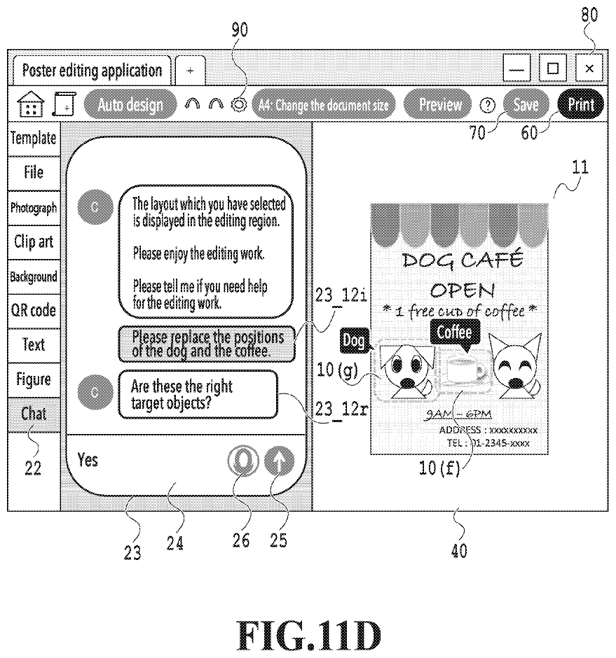

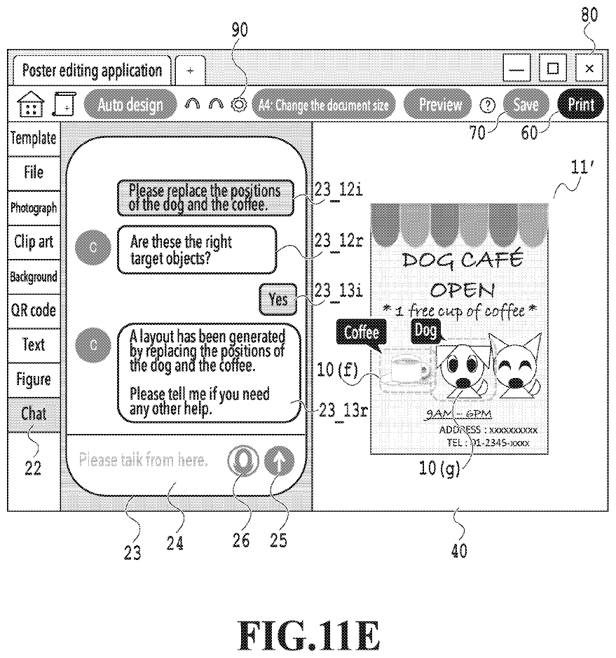

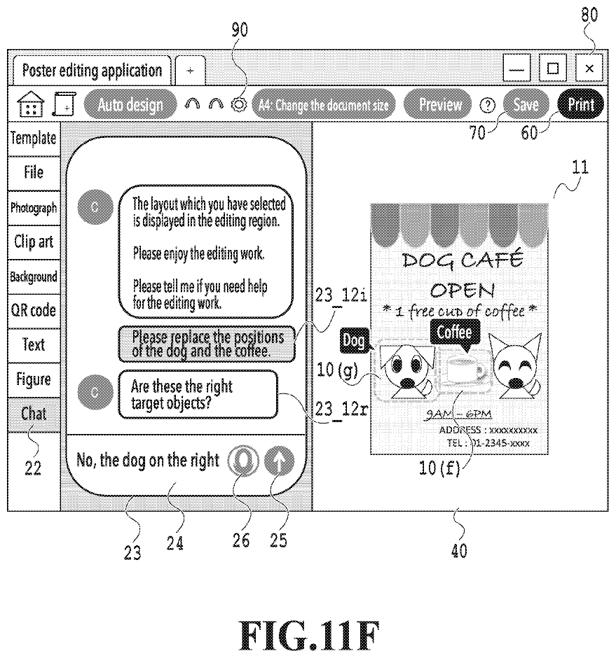

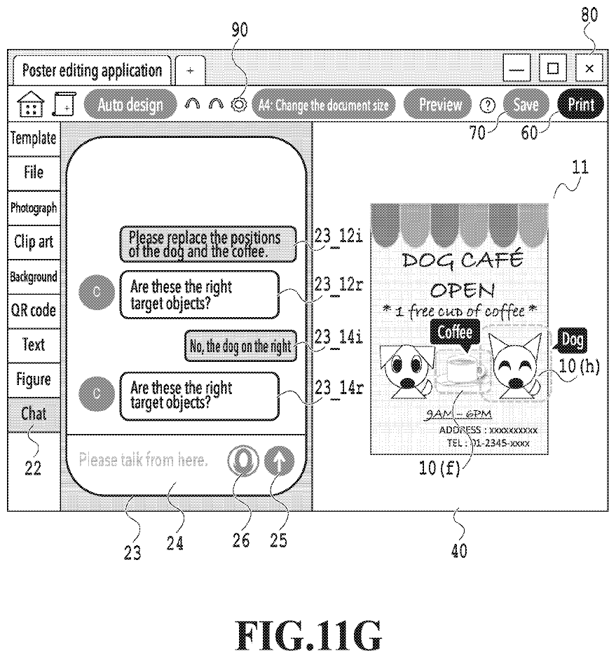

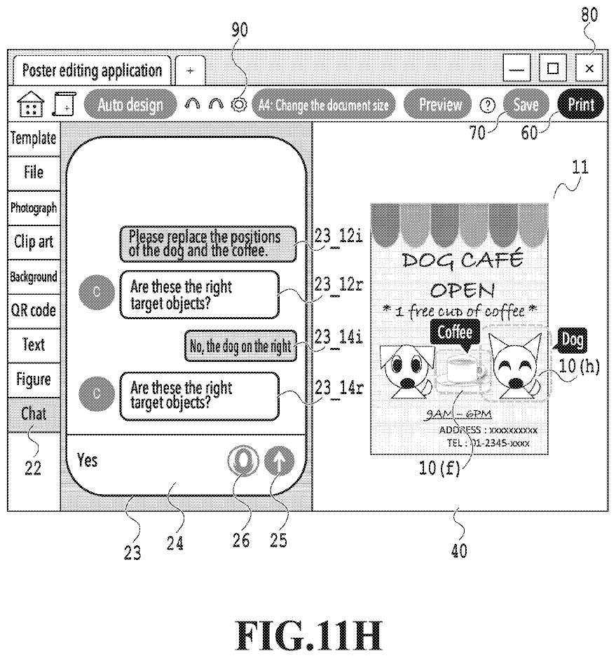

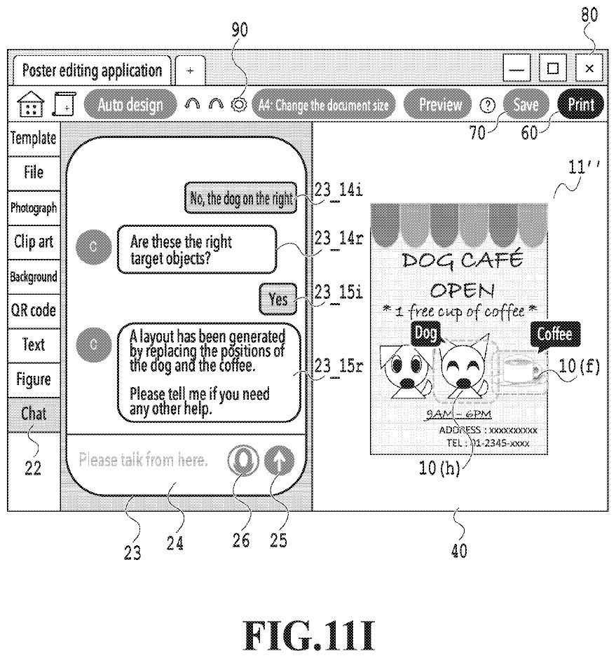

Layout editing via a bi-directional interactive I/F, which is a feature of the present embodiment, will be described by using a flowchart of FIG. 10 and examples of UI screens of FIG. 11A to FIG. 11I. In the present embodiment, at the stage where a change instruction is received, the user is prompted to check whether an object according to the change instruction is an object intended by the user. In a case where the object is a correct object, a new layout proposal based on the change instruction is generated and displayed. Here, a case where the editing processing is started via a UI screen of FIG. 11A, which corresponds to aforementioned FIG. 4E, will be described as an example. Now, in the editing area 40 of the UI screen of FIG. 11A, a layout proposal 11 containing an image object 10(f) of a coffee cup and image objects 10(g) and 10(h) of two different dogs is disposed. The processing of the flowchart of FIG. 10 is started in response to an operation (for example, mouseover with the cursor) of focusing on the input field 24 of the interactive area 23 by the user in the UI screen of FIG. 11A. Note that in the following description, sign “S” means a step.

In S1001, the CPU 203 receives a change instruction for an editing target layout proposal displayed in the editing area 40. FIG. 11B shows a UI screen in a case where the user has inputted a character string (text) “Please replace the positions of the dog and the coffee” into the input field 24 of the interactive area 23 in the UI screen of FIG. 11A. In a case where the user presses down the send button 25 in the UI screen of FIG. 11B, the CPU 203 proceeds to processing of S1002.

In S1002, as shown in FIG. 11C, the CPU 203 adds identification information to objects which are assumed to be objects according to the change instruction received in S1001 among the objects included in the layout proposal in the editing area 40, and displays the objects with the identification information. In the example of FIG. 11C, the objects included in the layout proposal are displayed in a recognizable manner with frames. Moreover, character strings “Coffee” and “Dog” which represent generic names of the objects, inputted by the user into the input field 24 in S1001, are displayed, as identification information, respectively near the corresponding image objects 10(f) and 10(g). In addition, in the interactive area 23 of the UI screen of FIG. 11C, a text message 23_12i indicating the instruction content “Please replace the positions of the dog and the coffee” of the user is displayed. Moreover, in the interactive area 23 of the UI screen of FIG. 11C, a text message (confirmation message) 23_12r “Are these the right target objects?” is displayed to prompt the user to check whether the objects are appropriate as the editing target objects. Here, in the example of the UI screen of FIG. 11C, there are two image objects 10(g) and 10(h) whose generic name is “Dog” in the editing target layout proposal 11. In a case where there are a plurality of objects of the same kind like this, these objects cannot be distinguished even by adding the character string “Dog” to these image objects as identification information. In view of this, by referring to the aforementioned object table, priorities of these two image objects of dogs are compared based on “ID-12” and “ID-13” of these two image objects of dogs, and the image object 10(g) having a higher priority is displayed as an editing target object. Note that in place of priorities set in advance, for example, objects may be displayed preferentially in order from an object which has been more frequently used in the past. Moreover, an object located at a higher position in a layout, for example, may be displayed preferentially based on positional coordinates in the editing target layout, or an object to be displayed preferentially may be determined based on a unique algorithm of a generative AI.

In S1003, the CPU 203 determines whether the object to which the identification information is added is appropriate as an editing target object based on a reply of the user which is inputted into the input field 24 of the interactive area 23, and switches processing to be executed next. Here, processing after cases are classified will be described with reference to specific example.

### <<In the Case Where the Target Object is OK>>

As shown in a UI screen of FIG. 11D, it is assumed that the user has inputted, for example, “Yes” into the input field 24 and has pressed down the send button 25. In this case, the CPU 203 determines that the object to which the identification information is added is appropriate as an editing target object, and proceeds to S1005.

In S1005, the CPU 203 generates a new layout proposal based on the change instruction received in S1001. The processing of the present step is basically the same as aforementioned S304, and the CPU 203 generates an input prompt based on the change instruction, and transmits a request for generating a new layout proposal to the server 120.

In S1006, the CPU 203 displays a layout proposal newly generated in S1005. Specifically, the CPU 203 displays the generated new layout proposal 11′ in the editing area 40 on the UI screen as shown in FIG. 11E. In the new layout proposal 11′, the image object 10(f) of a coffee cup and the image object 10(g) of a dog have been replaced with each other. In addition, in the interactive area 23 of the UI screen of FIG. 11E, a text message 23_13i indicating the change instruction of the user and a text message 23_13r as a reply to the text message 23_13i are displayed.

In S1007, the CPU 203 determines whether to continue or complete the editing processing via the interactive I/F. In a case where a user operation of inputting a new change instruction is detected, the CPU 203 returns to S1001 for continuing the editing processing, and repeats the processing based on the new change instruction. On the other hand, in a case where a user operation other than a new change instruction is detected, the CPU 203 exits the present processing, and returns to the flowchart of aforementioned FIG. 3.

### <<In the Case Where the Target Object is NG>>

As shown in a UI screen of FIG. 11F, it is assumed that the user has inputted, for example, “No, the dog on the right” into the input field 24 and has pressed down the send button 25. In this case, the CPU 203 determines that the object to which the identification information is added is inappropriate as an editing target object, and proceeds to S1004.

In S1004, the CPU 203 determines an object to which to add identification information from the other objects present in the layout proposal. After the determination, the CPU 203 returns to the processing of S1002, and adds identification information to the determined object, and display the object with the identification information, and displays the above-mentioned confirmation message. FIG. 11G shows a UI screen after transition from FIG. 11F. In this example, the identification information is added to the image object 10(h) having a lower priority among two image objects of dogs, and the image object 10(h) is displayed as an editing target object. In addition, in the interactive area 23 of the UI screen of FIG. 11G, a text message 23_14i indicating the change instruction of the user and a confirmation message 23_14r as a reply to the text message 23_14i are displayed.

In subsequent S1003, the CPU 203 determines whether the object to which the identification information is added is appropriate as an editing target object based on the reply of the user, which is inputted into the input field 24 of the interactive area 23, and switches processing to be executed next. Now, as shown in a UI screen of FIG. 11H, it is assumed that the user has inputted, for example, “Yes” into the input field 24 and has pressed down the send button 25. In this case, the CPU 203 determines that the object to which the identification information is added is appropriate as an editing target object, and proceeds to S1005.

In S1005, the CPU 203 generates a new layout proposal based on the change instruction received in S1001. The processing of the present step is basically the same as aforementioned S304, and the CPU 203 generates an input prompt based on the change instruction, and transmits a request for generating a new layout proposal to the server 120.

In S1006, the CPU 203 displays a layout proposal newly generated in S1005. Specifically, the CPU 203 displays the generated new layout proposal 11″ in the editing area 40 on the UI screen as shown in FIG. 11I. In the new layout proposal 11″, the image object 10(f) of a coffee cup and the image object 10(h) of a dog have been replaced with each other. In addition, in the interactive area 23 of the UI screen of FIG. 11I, a text message 23_15i indicating the change instruction of the user and a text message 23_15r as a reply to the text message 23_15i are displayed.

As described above, it becomes possible for the user to generate a layout intended by the user by bi-directionally communicating with the generative AI via the interactive I/F using identification information added to each object.

### Modification 1

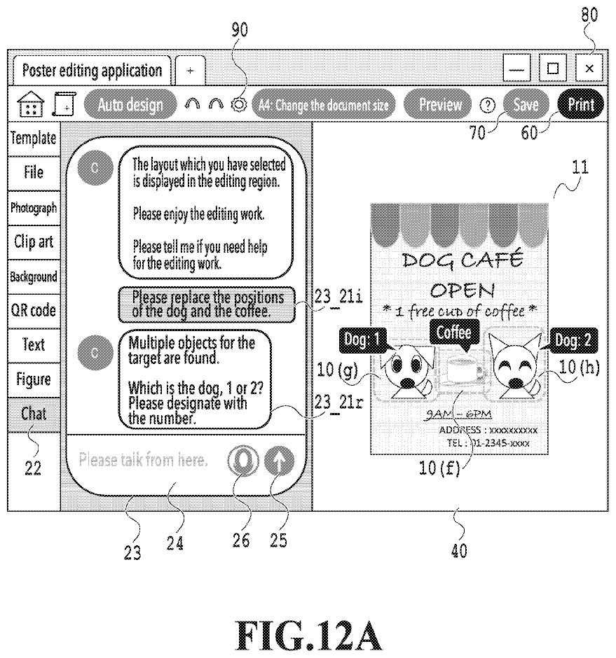

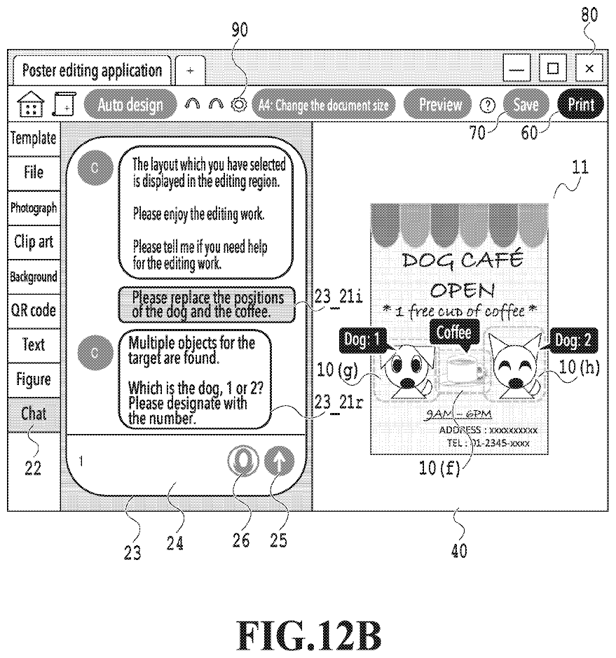

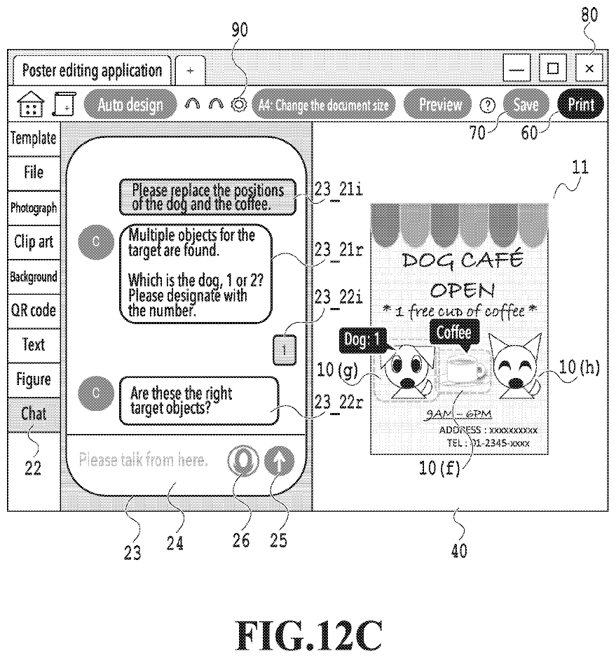

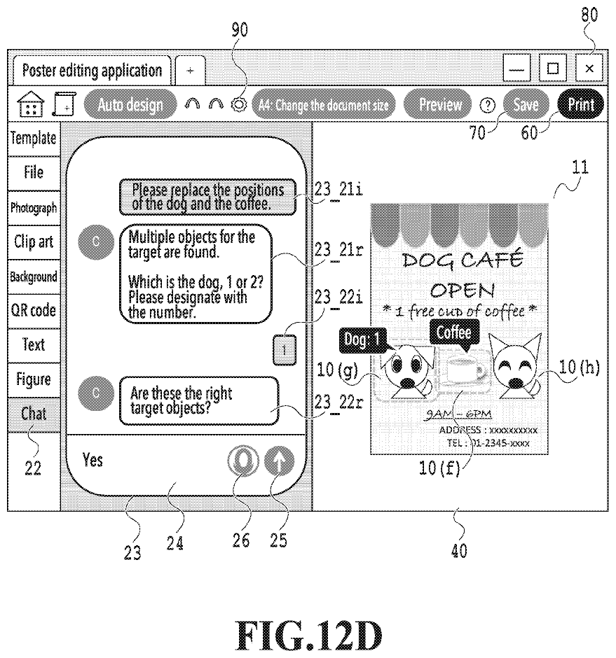

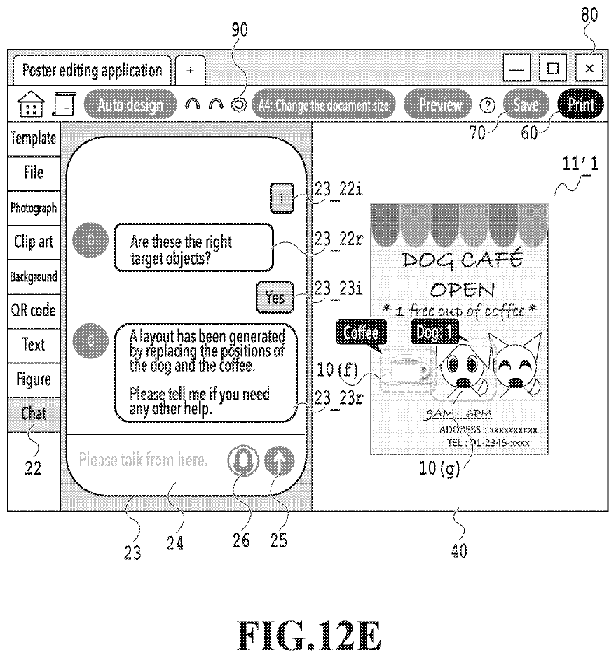

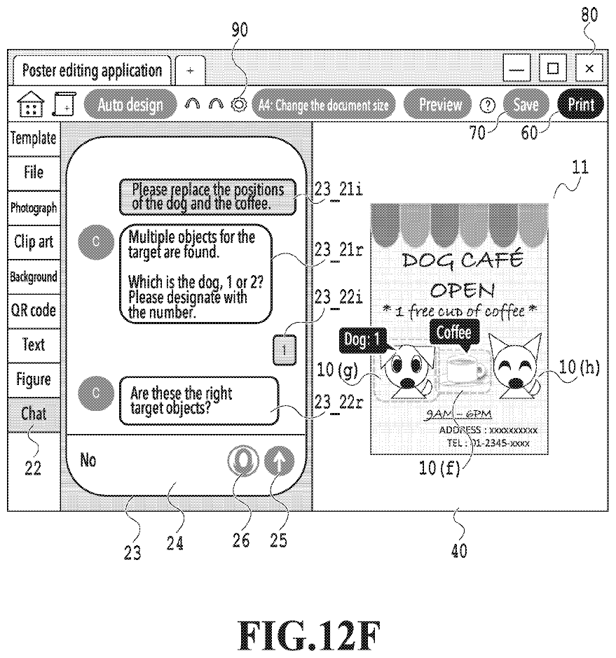

In the above-mentioned embodiment, in the case where there are a plurality of objects which can be subjected to a change instruction, the order of adding identification information is determined based on priorities; however, the configuration is not limited to this. For example, identification information which allows the plurality of objects to be distinguished from each other may be simultaneously added to the plurality of objects and displayed. Hereinafter, Modification 1 will be described by using examples of UI screens of FIG. 12A to FIG. 12F.

Now, in S1002 after a change instruction of the user has been received in S1001, as shown in FIG. 12A, a character string “Coffee” is added as identification information to the object 10(f) which cannot be confused with the other objects. Then, a character string “Dog: 1” and a character string “Dog: 2” are added as identification information to two image objects 10(g) and 10(h) which can be confused with another object only with the generic name. In addition, in the interactive area 23, a text message 23_21i indicating the instruction content “Please replace the positions of the dog and the coffee” of the user and a text message 23_21r “Multiple objects for the target are found. Which is the dog, 1 or 2? Please designate with the number.” as a reply to the text message 23_21i are displayed to prompt the user to select the object to be the editing target. Then, as shown in a UI screen of FIG. 12B, in a case where the user inputs “1” into the input field 24 and presses down the send button 25, it is determined that the editing target object is the image object 10(g) of “Dog: 1”. As a result, as shown in a UI screen of FIG. 12C, the object 10(g) corresponding to the character string “Dog: 1” is displayed as the editing target object in the editing area 40. In addition, in the interactive area 23 of the UI screen of FIG. 12C, a text message 23_22i indicating the instruction content “1” of the user and a confirmation message 23_22r as a reply to the text message 23_22i are displayed.

In subsequent S1003, it is determined whether the object to which the character string as the identification information is added is appropriate as an editing target object based on the reply of the user, which has been inputted into the input field 24 of the interactive area 23, and processing to be executed next is switched. Here, as shown in a UI screen of FIG. 12D, in a case where the user inputs “Yes” into the input field 24 and pressed down the send button 25, it is determined that the object to which the identification information is added is appropriate as an editing target object, and the processing proceeds to S1005. On the other hand, as shown in a UI screen of FIG. 12F, in a case where the user inputs “No” into the input field 24 and pressed down the send button 25, in S1004, the other object among the objects which can be confused with each other is determined as an object to which to add identification information. Then, the processing returns to the processing of S1002, and the identification information is added to the determined object, and a confirmation message 23_22r “Are these the right target objects?” is displayed. Such processing is repeated until an object to which a character string as identification information is added is determined to be appropriate as an editing target object.

The processing after the editing target objects have been determined to be appropriate is not particularly different from that in the above-mentioned embodiments. That is, a new layout proposal is generated in S1005, and the layout proposal thus generated is displayed on the UI screen in S1006. FIG. 12E is a diagram showing an example of a UI screen containing a newly generated layout proposal 11′_1, to which the UI screen transitioned from the UI screen of FIG. 12D. In the layout proposal 11′_1 displayed in the editing area 40 of the UI screen of FIG. 12E, the image object 10(f) of a coffee cup and the image object 10(g) of a dog on the left have been replaced with each other. In addition, in the interactive area 23 of the UI screen of FIG. 12E, a text message 23_23i indicating a reply content “Yes” of the user and a text message 23_23r indicating that the layout has been generated in accordance with the user instruction are displayed.

### Modification 2

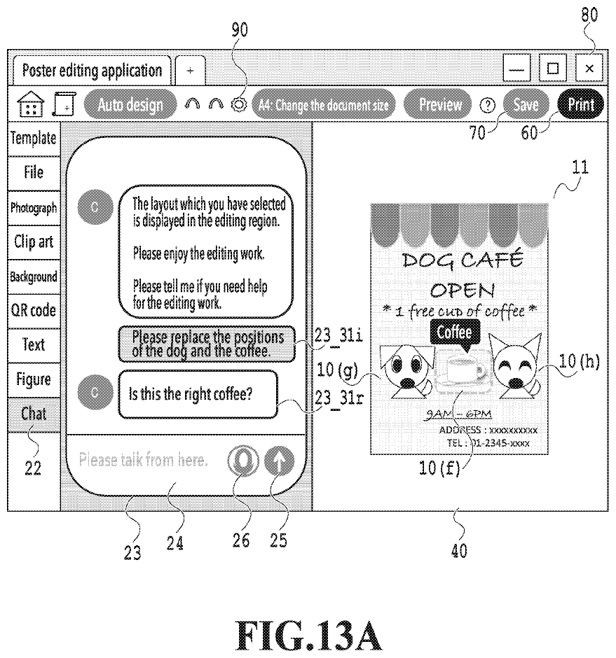

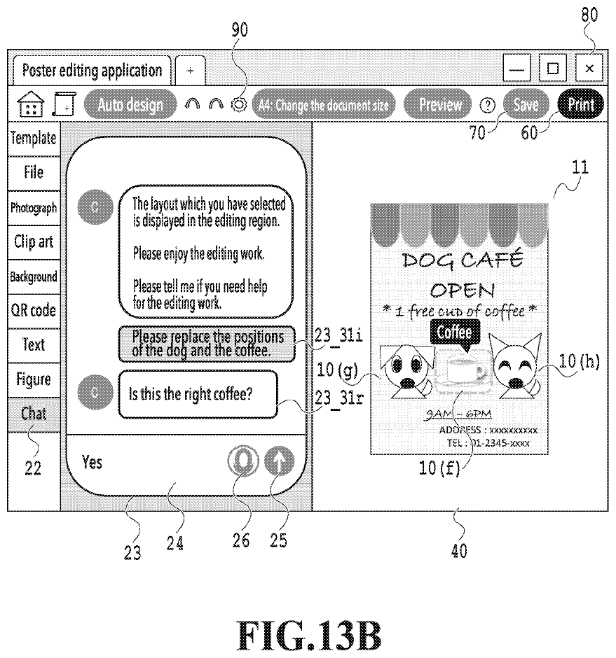

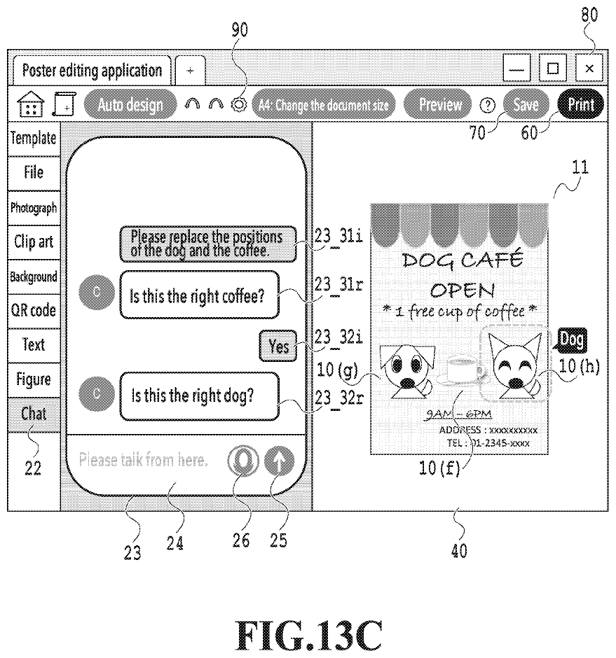

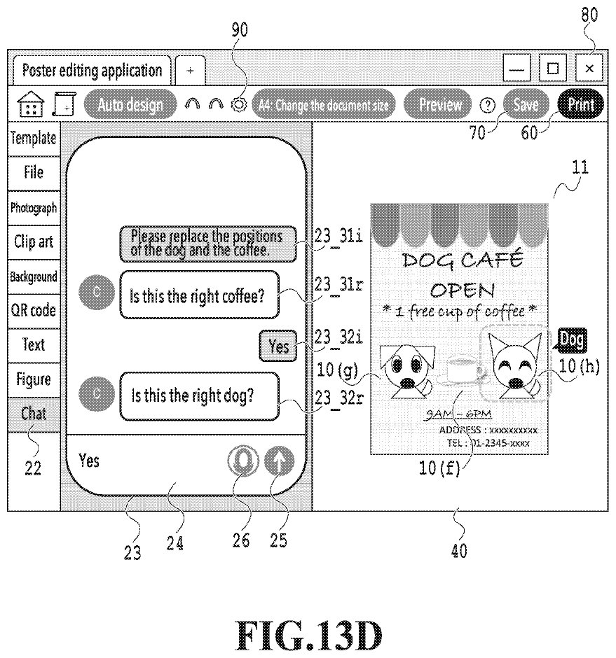

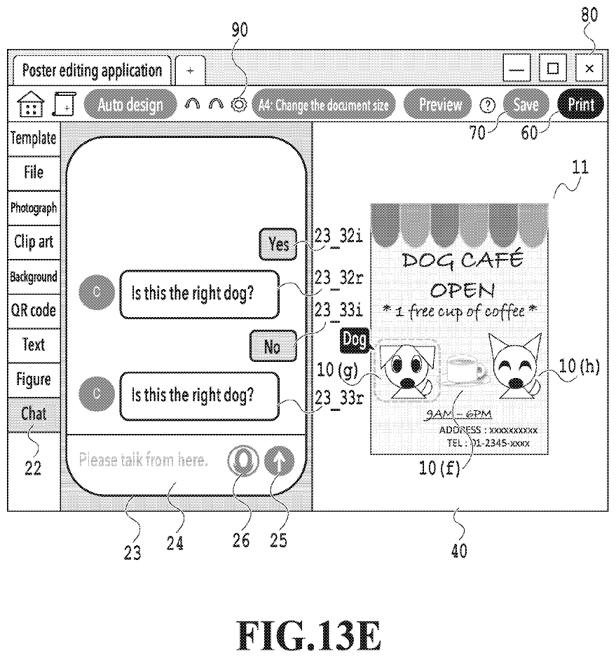

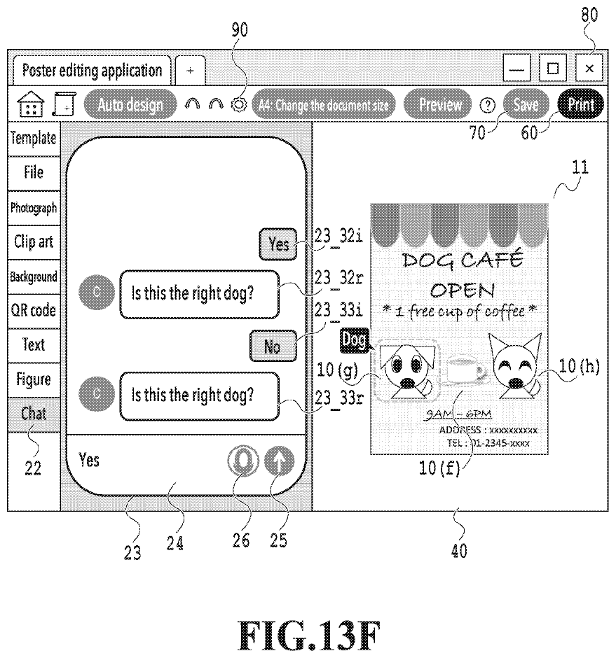

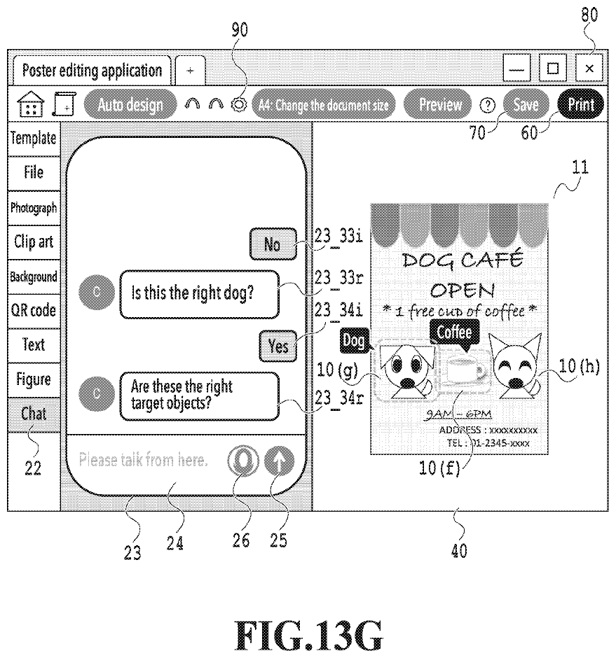

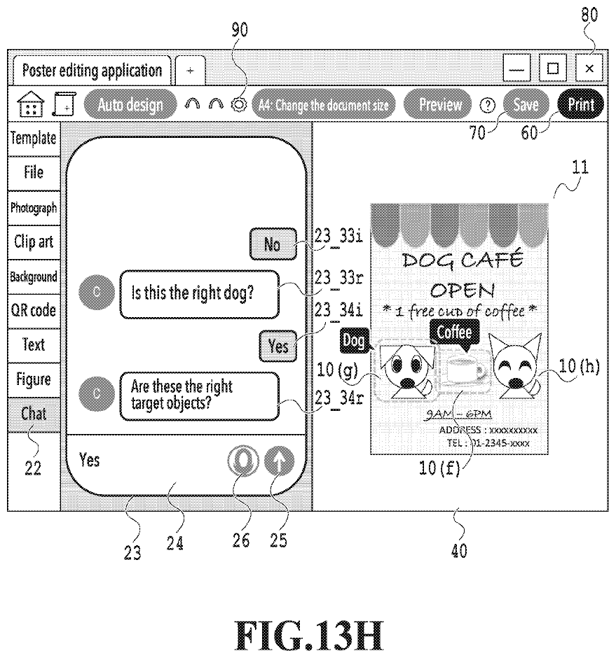

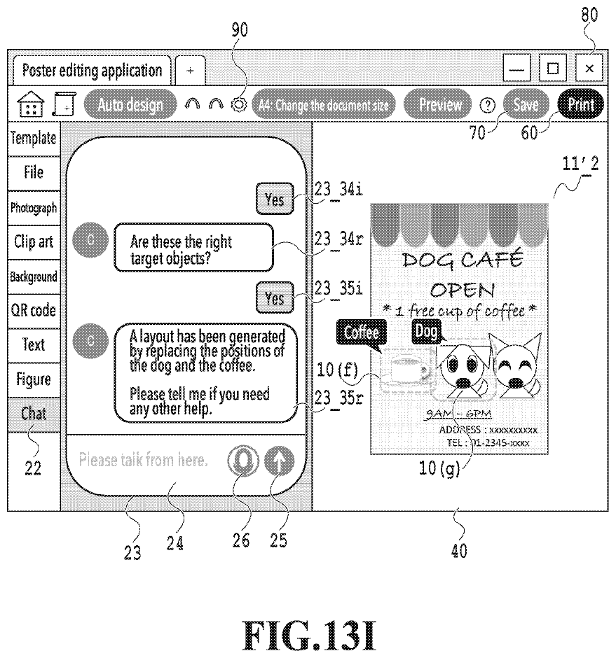

In addition, in a case where there are a plurality of objects which can be subjected to the change instruction of the user in a layout proposal displayed in the editing area 40, the user may be asked to check whether each of the plurality of objects is an object intended by the user sequentially one by one. Hereinafter, the configuration will be described by using examples of UI screens of FIG. 13A to FIG. 13I.

In S1002 after the change instruction of the user has been received in S1001, the CPU 203 adds identification information to each of objects relating to the change instruction sequentially one by one, and asks the user to check whether the object is appropriate as an editing target object. A specific procedure is as described below.

Now, a character string “Coffee” as identification information is added to only the image object 10(f) of a coffee cup among the objects relating to the change instruction on a UI screen of FIG. 13A. In addition, in the interactive area 23, a text message 23_31i indicating an instruction content “Please replace the positions of the dog and the coffee” of the user and a confirmation message 23_31r “Is this the right coffee?” are displayed. This confirmation message 23_31r prompts the user to check whether the image object 10(f) to which the identification information is added is appropriate as an editing target object. Then, as shown in a UI screen of FIG. 13B, in a case where the user inputs “Yes” into the input field 24 and presses down the send button 25, the image object 10(f) of a coffee cup is determined as the editing target object, and the UI screen transitions to a UI screen of FIG. 13C.

In the UI screen of FIG. 13C, a character string “Dog” as identification information is added to only one image object 10(h) of a dog among the remaining objects of the objects relating to the change instruction. In addition, in the interactive area 23, a text message 23_32i indicating the immediately preceding reply content “Yes” of the user and a confirmation message 23_32r “Is this the right dog?” are displayed. This confirmation message 23_32 r prompts the user to check whether the image object 10(h) to which the identification information is added is appropriate as an editing target object. Here, as shown in a UI screen of FIG. 13D, in a case where the user inputs “No” into the input field 24 and presses down the send button 25, it is determined that the object to which the identification information is now added is inappropriate as an editing target object, and the UI screen transitions to a UI screen of FIG. 13E.

In the UI screen of FIG. 13E, the character string “Dog” as identification information is added to only one image object 10(g) of a dog among the remaining objects of the objects relating to the change instruction. In addition, in the interactive area 23, a text message 23_33i indicating the immediately preceding reply content “No” of the user and a confirmation message 23_33r “Is this the right dog?” are displayed. This confirmation message 23_33 r prompts the user to check whether the image object 10(g) to which the identification information is added is appropriate as an editing target object. Then, as shown in a UI screen of FIG. 13F, in a case where the user inputs “Yes” into the input field 24 and presses down the send button 25, the image object 10(g) of the dog on the left is determined as an editing target object, and the UI screen transitions to a UI screen of FIG. 13G. In the UI screen of FIG. 13G, the identification information is added to the image object 10(f) of a coffee cup and the image object 10(g) of a dog on the left, and these are displayed as editing target objects. In addition, in the interactive area 23, a text message 23_34i indicating the immediately preceding reply content “Yes” of the user and a confirmation message 23_34r “Are these the right target objects?” are displayed. This confirmation message 23_34 r prompts the user to check whether the image objects 10(f) and 10(g) to which the identification information is added are appropriate as editing target objects.

In subsequent S1003, it is determined whether the objects to which the character strings as identification information are added are appropriate as editing target objects based on the reply of the user, which has been inputted into the input field 24 of the interactive area 23, and processing to be executed next is switched. Here, as shown in a UI screen of FIG. 13H, in a case where the user inputs “Yes” into the input field 24 and presses down the send button 25, it is determined that the objects to which the identification information is added are appropriate as editing target objects, and the processing proceeds to S1005.

The processing after the editing target objects have been determined to be appropriate is not particularly different from that in the above-mentioned embodiment. That is, a new layout proposal is generated in S1005, and the layout proposal thus generated is displayed on the UI screen in S1006. FIG. 13I is a diagram showing an example of a UI screen containing a newly generated layout proposal 11′_2, to which the UI screen transitioned from the UI screen of FIG. 13H. In the layout proposal 11′_2 displayed in the editing area 40 of the UI screen of FIG. 13I, the image object 10(f) of a coffee cup and the image object 10(g) of a dog on the left have been replaced with each other. In addition, in the interactive area 23 of the UI screen of FIG. 13I, a text message 23_35i indicating a reply content “Yes” of the user and a text message 23_53r indicating that the layout has been generated in accordance with the user instruction are displayed.

### Modification 3

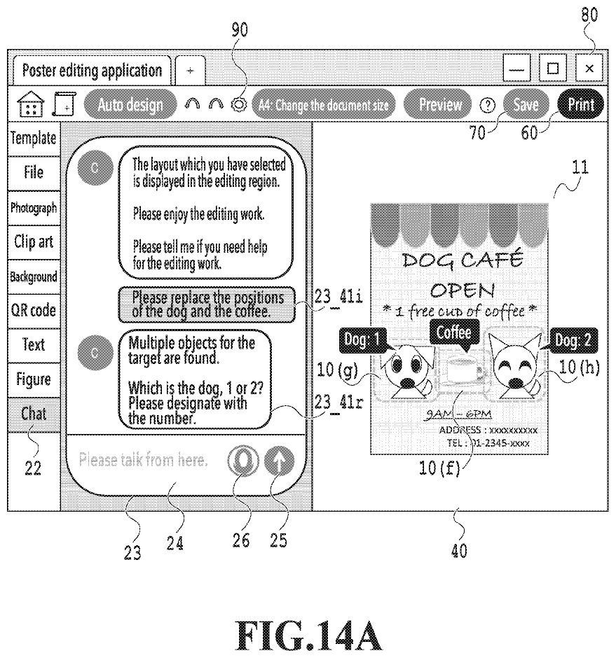

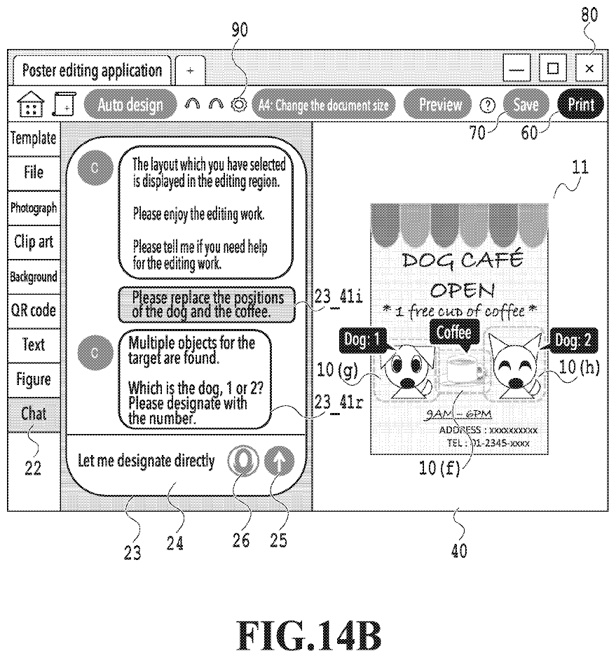

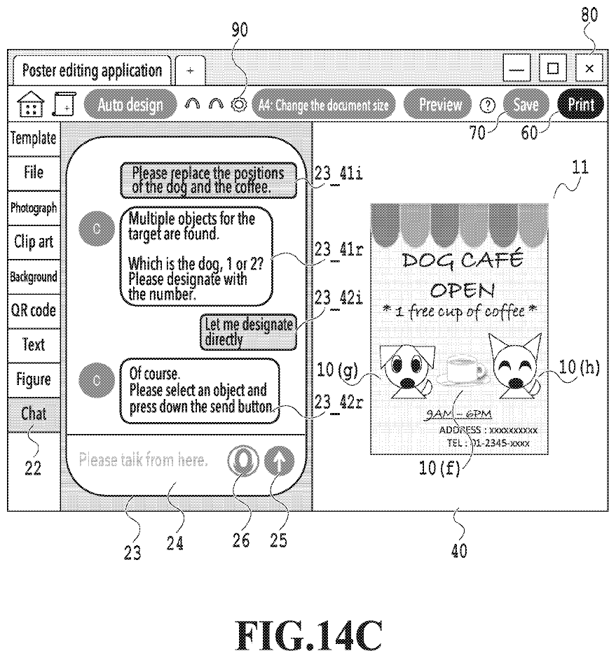

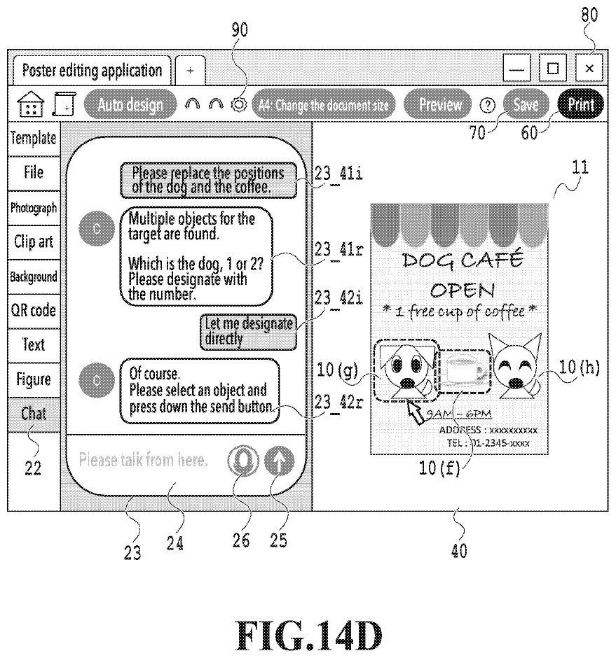

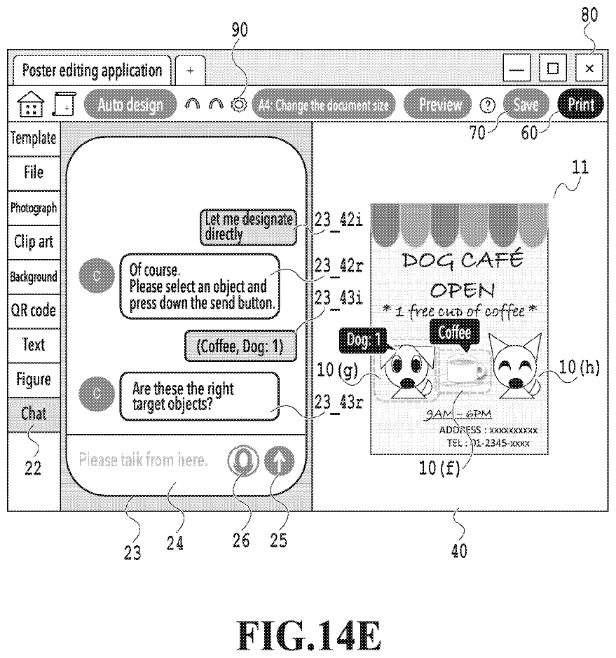

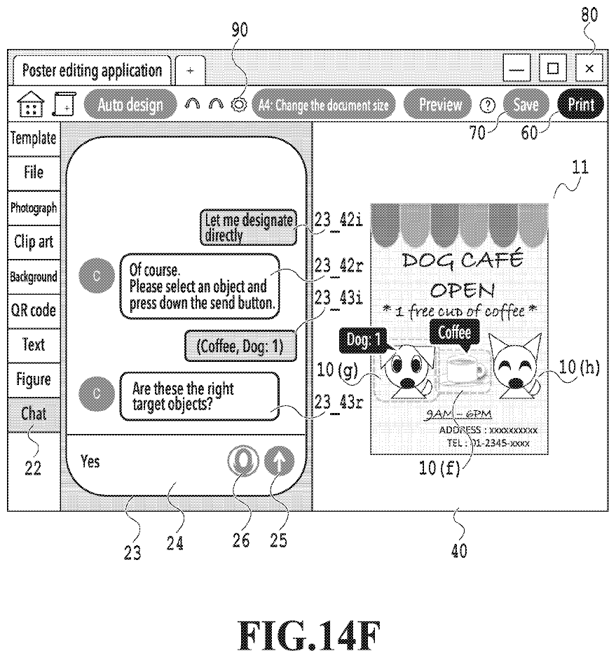

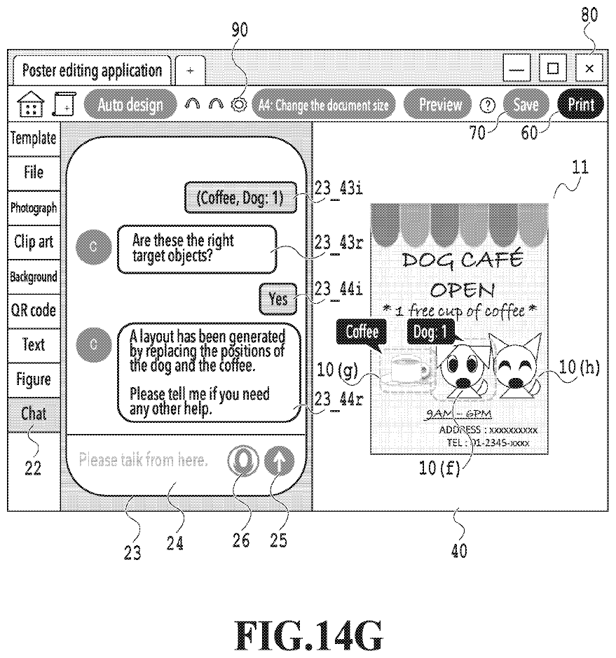

A configuration in which the method for designating an editing target object can be switched from an interactive I/F to GUI may be employed. Hereinafter, the configuration will be described by using examples of UI screens of FIG. 14A to FIG. 14G.

Now, in S1002 after a change instruction of the user has been received in S1001, as shown in FIG. 14A, a character string “Coffee” is added as identification information to the object 10(f) which cannot be confused with the other objects. Then, a character string “Dog: 1” and a character string “Dog: 2” are added as identification information to two image objects 10(g) and 10(h) which can be confused with the other object only with the generic name. In addition, in the interactive area 23, a text message 23_41i indicating the instruction content “Please replace the positions of the dog and the coffee” of the user and a text message 23_41r “Multiple objects for the target are found. Which of 1 and 2, is the dog? Please designate with the number.” as a reply to the text message 23_41i are displayed to prompt the user to select the object to be the editing target. Then, as shown in a UI screen of FIG. 14B, in a case where the user inputs “Let me designate directly” into the input field 24 and presses down the send button 25, the method for designating an object is switched. That is, the method is switched from the designation through bi-directional communication using the interactive I/F to direct designation using GUI (Graphical User Interface), and the UI screen transitions to a UI screen of FIG. 14C. Thereafter, in an editing area 40 of the UI screen of FIG. 14C, object selection using a mouse or the like by the user is received. In this event, in the interactive area 23, the text message 23_42i indicating the instruction content “Let me designate directly” of the user and a text message 23_42r “Of course. Please select an object and press down the send button.” as a reply to the text message 23_42i are displayed. Here, as shown in a UI screen of FIG. 14D, in a case where the user selects two image objects 10(f) and 10(g) and presses down the send button 25, these two image objects 10(f) and 10(g) are determined as editing target objects, and the UI screen transitions to a UI screen of FIG. 14E. In the UI screen of FIG. 14E, identification information is added to the image object 10(f) of a coffee cup and the image object 10(g) of a dog on the left, and these are displayed as editing target objects. In addition, in the interactive area 23, a text message 23_43i indicating the content “(Coffee, Dog: 1)” of the user selection and a confirmation message 23_43r “Are these the right target objects?” are displayed. This confirmation message 23_43 r prompts the user to check whether the image objects 10(f) and 10(g) to which the identification information is added are appropriate as editing target objects.

In subsequent S1003, it is determined whether the objects to which the character strings as identification information are added are appropriate as editing target objects based on the reply of the user, which has been inputted into the input field 24 of the interactive area 23, and processing to be executed next is switched. Here, as shown in a UI screen of FIG. 14F, in a case where the user inputs “Yes” into the input field 24 and presses down the send button 25, it is determined that the objects to which the identification information is added are appropriate as editing target object, and the processing proceeds to S1005.

The processing after the editing target objects have been determined to be appropriate is not particularly different from that in the above-mentioned embodiment. That is, a new layout proposal is generated in S1005, and the layout proposal thus generated is displayed on the UI screen in S1006. FIG. 14G is a diagram showing an example of a UI screen containing a newly generated layout proposal 11′_3, to which the UI screen transitioned from the UI screen of FIG. 14F. In the layout proposal 11′_3 displayed in the editing area 40 of the UI screen of FIG. 14G, the image object 10(f) of a coffee cup and the image object 10(g) of a dog on the left have been replaced with each other. In addition, in the interactive area 23 of the UI screen of FIG. 14G, a text message 23_44i indicating a reply content “Yes” of the user and a text message 23_44r indicating that the layout has been generated in accordance with the user instruction are displayed. Note that in the present Modification, the switching from the object designation using the interactive I/F to the object designation using the GUI is made based on the user instruction; however, the switching may be made automatically. For example, in a case where it is difficult to determine an editing target object intended by the user such as a case where even if the processing of S1002 to S1004 is repeated predetermined times, the processing does not proceed to the processing of S1005, the switching may be made automatically. In a case where such automatic switching is made, a message such as “Please designate directly.”, for example, is displayed. Moreover, a configuration may be employed in which in a case where even if the processing of S1002 to S1004 is repeated predetermined times, the processing does not proceed to the processing of S1005, the generation of a layout proposal is executed immediately without prompting the user to select an object. Note that in this case, the number of remaining operations until the layout generation processing starts may be displayed on the UI screen.

As described above, the user can perform the editing work while checking whether an object intended by the user has become an editing target via the bi-directional interactive I/F, making it possible for the user to generate a desired layout through interaction.

The embodiments including the aforementioned Modifications can be combined as appropriate to be applied, and the Web application 121 may have some or all of the functions of the embodiments including Modifications.

### Other Embodiments

Embodiment(s) of the present disclosure can also be realized by a computer of a system or apparatus that reads out and executes computer executable instructions (e.g., one or more programs) recorded on a storage medium (which may also be referred to more fully as a ‘non-transitory computer-readable storage medium’) to perform the functions of one or more of the above-described embodiment(s) and/or that includes one or more circuits (e.g., application specific integrated circuit (ASIC)) for performing the functions of one or more of the above-described embodiment(s), and by a method performed by the computer of the system or apparatus by, for example, reading out and executing the computer executable instructions from the storage medium to perform the functions of one or more of the above-described embodiment(s) and/or controlling the one or more circuits to perform the functions of one or more of the above-described embodiment(s). The computer may comprise one or more processors (e.g., central processing unit (CPU), micro processing unit (MPU)) and may include a network of separate computers or separate processors to read out and execute the computer executable instructions. The computer executable instructions may be provided to the computer, for example, from a network or the storage medium. The storage medium may include, for example, one or more of a hard disk, a random-access memory (RAM), a read only memory (ROM), a storage of distributed computing systems, an optical disk (such as a compact disc (CD), digital versatile disc (DVD), or Blu-ray Disc (BD)™), a flash memory device, a memory card, and the like.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

According to the present disclosure, the intention of the user can be correctly reflected and the convenience can be improved in a scene where a layout design of contents is performed by using an interactive interface.

This application claims the benefit of Japanese Patent Application No. 2025-073761, filed Apr. 25, 2025 which is hereby incorporated by reference herein in its entirety.

What is claimed is:

1. A non-transitory computer readable storage medium storing a program for causing a computer to generate a layout of contents by executing the following processing:
causing a display device to display a first layout proposal relating to the contents;
receiving a change instruction for the first layout proposal from a user via an interactive interface; and
generating a second layout proposal of the contents by changing the first layout proposal based on the change instruction.

2. The storage medium according to claim 1, wherein
the interactive interface includes an interface screen for interactive communication, in which objects included in the first layout proposal are displayed in a recognizable manner, and
the user gives, via the interface screen, the change instruction for at least one object among the objects included in the first layout proposal.

3. The storage medium according to claim 2, wherein
in the interface screen, identification information is added to each of the objects included in the first layout proposal.

4. The storage medium according to claim 3, wherein
the identification information is a number which allows each of the objects included in the first layout proposal to be uniquely specified.

5. The storage medium according to claim 3, wherein
the identification information is a generic name of each of the objects included in the first layout proposal.

6. The storage medium according to claim 5, wherein
in the interface screen, the generic name is added, as the identification information, to an object which is assumed to be an object to be subjected to the change instruction among the objects included in the first layout proposal.

7. The storage medium according to claim 6, wherein
in a case where there are a plurality of objects of the same kind which are assumed to be objects to be subjected to the change instruction, the generic name is added, as the identification information, to one object among the plurality of objects of the same kind based on priorities set in advance.

8. The storage medium according to claim 6, wherein
in a case where there are a plurality of objects of the same kind which are assumed to be objects to be subjected to the change instruction, the generic name is added, as the identification information, to one object among the plurality of objects of the same kind.

9. The storage medium according to claim 8, wherein
a message which prompts the user to check whether the one object to which the generic name is added is an object to be subjected to the change instruction is displayed in the interface screen.

10. The storage medium according to claim 6, wherein
in a case where there are a plurality of objects of the same kind which are assumed to be objects to be subjected to the change instruction, the generic name is added, as the identification information, to each of the plurality of objects of the same kind, and
a message which prompts the user to check whether object is an object to be subjected to the change instruction among the plurality of objects of the same kind to each of which the generic name is added is displayed in the interface screen.

11. The storage medium according to claim 1, wherein
an adjustment of an object to be subjected to the change instruction is performed in conformity to a framework of the second layout proposal to be generated.

12. The storage medium according to claim 11, wherein
in addition to the adjustment of the object to be subjected to the change instruction, another object relevant to the object to be subjected to the change instruction among the objects included in the first layout proposal is adjusted.

13. The storage medium according to claim 1, further causing the computer to execute the following processing:
setting the generated second layout proposal as an editing target.

14. The storage medium according to claim 1, wherein the second layout proposal is generated by a generative AI.

15. The storage medium according to claim 1, further causing the computer to execute the following processing:
generating a plurality of the first layout proposals, wherein
the plurality of first layout proposals generated are displayed on the display device.

16. The storage medium according to claim 15, wherein
the first layout proposals are generated by a generative AI.

17. The storage medium according to claim 1, wherein
the interactive interface is a user interface through which the user gives the change instruction by using text input.

18. The storage medium according to claim 1, wherein
the interactive interface is a user interface through which the user gives the change instruction by using voice input.

19. An information processing apparatus for generating a layout of contents, comprising:
one or more memories storing instructions; and
one or more processors executing the instructions to:
cause a display device to display a first layout proposal relating to the contents;
receive a change instruction for the first layout proposal from a user via an interactive interface; and
generate a second layout proposal of the contents by changing the first layout proposal based on the change instruction.

20. An information processing method for generating a layout of contents, the information processing method comprising causing a computer to execute the steps of:
causing a display device to display a first layout proposal relating to the contents;
receiving a change instruction for the first layout proposal from a user via an interactive interface; and
generating a second layout proposal of the contents by changing the first layout proposal based on the change instruction.
